(19) United States
(12) Patent Application Publication
(10) Pub. No.: US 2025/0021076 A1
(43) Pub. Date: Jan. 16, 2025

(54) DIRECTIONAL IMAGING BASED TOOLPATH DETERMINATION

(71) Applicant: Regents of the University of Minnesota, Minneapolis, MN (US)

(72) Inventors: Meghan Rochelle Griffin, Saint Paul, MN (US); Spencer Ernest Bertram, Saint Cloud, MN (US); Michael C. McAlpine, Minneapolis, MN (US); Caleb Darwin Vogt, Brooklyn Park, MN (US); Angela Panoskaltsis-Mortari, Woodbury, MN (US); Ravi Janardan, Plymouth, MN (US)

(21) Appl. No.: 18/769,027

(22) Filed: Jul. 10, 2024

Related U.S. Application Data
(60) Provisional application No. 63/512,841, filed on Jul. 10, 2023.

(51) Int. Cl. G05B 19/4099

(52) U.S. Cl. CPC G05B 19/4099; G05B 2219/49023

(57) ABSTRACT

Devices, systems, and techniques are described for determining toolpaths for printing constructs with microarchitecture. For example, a method includes receiving, by processing circuitry, imaging data representative of a target structure; determining, by the processing circuitry and based on the imaging data, a map of material tracks for the target structure; determining, by the processing circuitry and from the map of material tracks, one or more toolpaths for depositing material to form a construct representative of the target structure; and generating, by the processing circuitry and based on the one or more toolpaths, computer code that defines a three-dimensional (3D) printing process for a printing nozzle to deposit the material to form the construct.

This application claims the benefit of U.S. Provisional Patent Application No. 63/512,841, filed 10 Jul. 2023, the entire contents of which is incorporated herein by reference.

### TECHNICAL FIELD

This disclosure relates generally to methods, systems, and devices for determining printing toolpaths.

### BACKGROUND

The precise micro-structural arrangements of certain target structures can affect the functionality of those target structures. For example, biological tissues are highly ordered by means of cell layers, cellular alignment, or both. The precise structural arrangement of cells contributes to tissue function. Mechanically active tissues including skeletal muscle, smooth muscle, cardiac muscle, tendons, and ligaments are all soft tissues structured with elongated cells that are aligned in the direction of the greatest stress. In long skeletal muscles and tendons, all cells are aligned in a single direction. However, cardiac muscle and the smooth muscle of the gastrointestinal and urogenital systems have layers of muscle with multiple directions of alignment.

### SUMMARY

This disclosure describes example techniques and systems for determining printing toolpaths for making and using three dimensional (3D)-printed models of target structures, such as anatomical structures printed with microstructures. In some examples described herein, a system can generate one or more toolpaths that define the 3D printing movements for depositing material (e.g., individual cells, microtissues containing multiple cells, or abiotic materials) into a construct. In one example, the system determines the one or more toolpaths from imaging data (e.g., diffusion tensor magnetic resonance imaging (DTMRI) or other imaging modalities) of a target structure. The target structure may be a sample target structure similar to the construct. The target structure may be a tissue structure such as a biological sample of tissue. The target structure may additionally or alternatively be any abiotic material or structure such as liquid crystal displays, rocket boosters and/or solid fuel deposition, concrete, or wood. In particular, the toolpaths described herein may be used to form any of these structures or other structures that may benefit from specific tracks or patterns of the material deposited during printing.

The system may generate a map of structural tracks from the imaging data. This map of structural tracks may illustrate the position of “fibers” of tissue that make up the tissue structure in the imaging data. These fibers may correspond to cells aligned in the same direction, such as muscle fibers, connective tissue, or any other tissue that has an alignment in a particular direction. The system may then generate one or more toolpaths from this map of structural tracks by removing, adding, or moving one or more of the structural tracks to accommodate any constraints of the 3D printing system. The system may then generate computer code that defines the movements of a 3D printing system (e.g., a tissue printing nozzle) along the one or more toolpaths to create the construct during 3D printing. Using the computer code, the 3D printing system may then print, or deposit, material along the one or more toolpaths to generate the construct.

In some examples, a method includes receiving, by processing circuitry, imaging data representative of a target structure; determining, by the processing circuitry and based on the imaging data, a map of material tracks for the target structure; determining, by the processing circuitry and from the map of material tracks, one or more toolpaths for depositing material to form a construct representative of the target structure; and generating, by the processing circuitry and based on the one or more toolpaths, computer code that defines a three-dimensional (3D) printing process for a printing nozzle to deposit the material to form the construct.

In another example, a system includes processing circuitry configured to receive imaging data representative of a target structure; determine a map of material tracks for the target structure based on the imaging data; determine one or more toolpaths for depositing material to form a construct representative of the target structure based on the material tracks; and generate computer code that defines a three-dimensional (3D) printing process for a printing nozzle to deposit the material to form the construct based on the toolpaths.

In another example, a computer-readable medium includes instructions that, when executed, cause processing circuitry to receive imaging data representative of a target structure; determine a map of material tracks for the target structure based on the imaging data; determine one or more toolpaths for depositing material to form a construct representative of the target structure based on the material tracks; and generate computer code that defines a three-dimensional (3D) printing process for a printing nozzle to deposit the material to form the construct based on the toolpaths.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a diagram of an example gastroesophageal junction (GEJ) fascicle arrangement in accordance with the examples of this disclosure.

FIG. 2 is a flowchart of an example process for determining printing paths and printing a construct.

FIG. 3 includes images of example DTMRI data after processing.

FIG. 4A is an image of example DTMRI data slice with a left ventricle wall outlined.

FIG. 4B is an image of an example mask for the DTMRI data slice of the left ventricle of FIG. 4A.

FIG. 4C is an image of an example 3D mask of the left ventricle of FIG. 4A.

FIG. 5A is an image of example tractography for a heart.

FIG. 5B is an image of an example pseudo-3D subsampled version of the tractography of FIG. 5A.

FIG. 5C is an image of example complete tractography for a heart of a patient using the 3D mask of FIG. 4C.

FIG. 6A is a graph of an example histogram of tracked streamline lengths in an example heart.

FIG. 6B is a graph of an example histogram of tracked streamline lengths after removing streamlines less than 2 mm in length.

FIG. 7 is a diagram of example toolpaths for printing the GEJ of FIG. 1.

FIG. 8A is a flowchart of an example technique for converting directional imaging data to G-code for instructing toolpaths for printing.

FIG. 8B is a flowchart of another example technique for converting directional imaging data to G-code for instructing toolpaths for printing.

FIG. 9A is a conceptual diagram of different streamlines for a toolpath.

FIG. 9B is a conceptual diagram illustrating distances between the streamlines of FIG. 9A.

FIG. 9C is a conceptual diagram illustrating the process of sweep exclusion.

FIG. 10A is a diagram illustrating example toolpaths which are cyclically dependent.

FIG. 10B is a state diagram illustrating the example toolpaths of FIG. 10A which are cyclically dependent.

FIG. 10C is a diagram illustrating the example toolpaths of FIG. 10A wherein a seam has been added create acyclical dependency.

FIG. 10D is a state diagram illustrating the example toolpaths of FIG. 10C which are acyclically dependent.

FIG. 11 is a diagram of a 3D printing process using a support medium that enables printing of complex geometries.

FIG. 12 is a flowchart of an example technique for determining a toolpath for printing a tissue construct.

FIG. 13 is a flowchart of an example technique for printing a tissue construct using a toolpath based on imaging data.

FIG. 14 is a graphical representation of pre-aligned microtissues in accordance with the example of this disclosure.

FIGS. 15A, 15B, and 15C are example cross-section and profile views of graphical representations of example fibers generated using a core-shell spinning technique.

FIGS. 16A and 16B are conceptual diagrams of an example spinning device for generating microtissue structures.

FIG. 17 is an image of an example printed structure using generated G-code.

FIG. 18 illustrates one example of a computing system used to execute the techniques of FIGS. 1-17, in accordance with one or more techniques of the disclosure.

### DETAILED DESCRIPTION

This disclosure describes example techniques for determining toolpaths for 3D printing structures, such as structures that may include complex micro-architecture. For example, biological tissues are highly ordered by means of cell layers, cellular alignment, or both and may have complex micro-architecture. As one example, natural muscle tissue generally exhibits a high degree of alignment that enables efficient directional force generation. The precise structural arrangement of cells is important to all tissue function. Mechanically active tissues including skeletal muscle, smooth muscle, cardiac muscle, tendons, and ligaments are all soft tissues structured with elongated cells that are aligned in the direction of the greatest stress. In long skeletal muscles and tendons, all cells are aligned in a single direction. In cardiac muscle, the smooth muscle of the gastrointestinal system, and the smooth muscle of the urogenital system, layers of muscle have multiple directions of alignment. Recreating the more complex structures found in these cardiac and smooth muscle tissues may be very difficult. More generally, planar, layer-by-layer approaches to determining toolpaths may not capture a directional complexity of structures with complex micro-architecture and determining non-planar toolpaths for structures with complex micro-architecture may be difficult.

Fiber architecture can be instrumental to the function of many biological tissues. For example, the myocardium of the heart includes a highly complex and nonplanar fiber structure that is central to the function of the heart. Diffusion tensor magnetic resonance imaging (DTMRI) is a clinical imaging modality capable of extracting complex tract geometry from tissue; however, cardiac biomanufacturing processes have yet to take advantage of the directional information DTMRI provides. 3D bioprinting of functional cardiac ventricle constructs have been limited by planar, layer-by-layer approaches-based on biologically uninformed 3D printing processes that do not fully capture the directional complexity of the myocardium.

A DTMRI-informed toolpath generation algorithm may output a sequence of 3D printable, non-interfering toolpaths, such that the resulting print-line architecture matches the micro-architecture of the target structure. In an example of toolpath generation for a left ventricle of a heart, a system may extract fiber paths may from a DTMRI scan of a human heart and the system may select a representative subset of those fiber paths. The system may order the paths in the representative subset to eliminate interference during material deposition and translate the resulting path sequence into G-code. Such a toolpath generation procedure enables 3D printing toolpath generation and the fabrication of fiber-oriented constructs that accurately recapitulate fiber structure and function of the target structure. Such a toolpath generation algorithm may improve bio-printing by enabling printing of cells according to the complex tract geometry of the target issue instead of printing the cells in a planar layer by layer approach, thereby improving a functionality of 3D printed tissue.

Cell alignment is a challenge in tissue engineering. Examples include single cell deposition and pre-alignment of cells within microtissues that may then be assembled into larger, macroscale tissues using technologies including 3D-bioprinting of these microtissues to create fibers of a suitable direction and position with respect to other fibers within a larger tissue construct. Microtissues that contain cells that are all aligned within the microtissue structure may be subassemblies that are then assembled into larger tissues. These microtissues may be configured to form suitable alignment structures including complicated tissue structures such as the GEJ.

Cellular alignment, in one direction, may be performed using geometric cues, remote fields, passive mechanics, and active mechanics. This process may be performed by creating a shape out of a scaffolding material (e.g., typically made from a biocompatible polymer or biopolymer), and to that cells are then added. This creates an immature “tissue construct.” This construct may then be matured in a bioreactor that applies signals including chemical, electrical, and mechanical stimulation to cause maturation of the tissue into a final form. One of the limitations of this method is that it is only able to produce one direction of cell alignment within tissues. The resulting tissue constructs are of limited complexity and are limited in physical scale. As described herein, microtissues of pre-aligned cells may be generated first and then printed in order to create fibers of deposited cells that have alignment in different directions as deposited during the printed process.

Described herein are systems and techniques for path planning for robotic deposition of material with anisotropy or alignment of various material properties of a final tissue construct. In some examples, path planning for 3D additive manufacturing is achieved via a program called a “slicer” that takes computerized models as inputs and produces a set of paths for material deposition. This process is usually done by generating a stack of 2D slices of the 3D object, resulting in layer-by-layer deposition of material with generic infill patterns. There are applications where the geometric, structural, and mechanical properties of the object are not well represented by 2D slices, nor by automatically-generated infill patterns within those slices. These applications include, but are not limited to: tissue engineering; tissue or imaging phantoms; fibrous polymeric materials; agricultural engineering and research; and geology.

Generally, the examples described herein relate to tissue engineering applications, although the toolpath techniques described may be used in other 3D printing applications as well. In tissue engineering, the alignment of cells and the arrangement of tissues within an organ are important to the structure and function of that particular tissue or organ. Without accurate replication of these characteristics, any resultant engineered tissue may not be able to perform its intended function, rendering it useless as a model system or a therapeutic tissue.

Specifically in cases such as the heart, brain, and gastroesophageal junction, there are cell bundles oriented in 3D that do not respect planar boundaries. Fabrication methods have been developed that may be able to generate suitable anisotropy in these tissues, but implementation currently relies on largely manual toolpath planning by an operator. For example, methods in extrusion bioprinting may cause muscle cells to align with the print nozzle's toolpath, but generating these toolpaths in a biologically relevant manner is difficult and may require extensive manual toolpath generation by an operator. Particularly, the 3D bioprinting published methods currently used have issues with accuracy because they continue to utilize existing slicer software with 2D planar slicing and generic infill patterns. Traditional 3D printing assumes that the outputs are constructed in a layer-by-layer fashion, restricting all deposition toolpaths to the X-Y plane. The 3D printer may be free to move along each of the X, Y, and Z axes simultaneously instead of just a single plane, or any combination of the X, Y, and Z axes as is suitable during the printing process. In some examples, the 3D printing system may utilize more than 3 degrees (or axes) of freedom to move and deposit cells during the printing process.

The 3D printer may employ hardware that executes commands from an input code, but generating this input code is difficult and missing a connection for implementation of complex cell alignment and tissue anisotropy for the printing of tissue constructs in three dimensions. Therefore, there is a need for a system and technique to create machine code from alignment data that would incorporate the microarchitecture data present in these target tissue structures and utilize complex, non-planar slicing methods, or other non-planar mapping, to accommodate biological structures.

In one example, a system may be configured to intake fiber tractography data (e.g., from imaging data) and produce G-code (e.g., an example of computer code), a type of machine code that defines movements for depositing material by most 3D printers. DTMRI is a specialized MRI sequence that maps a diffusion tensor, which contains information about which direction in space water molecules are most free to move back and forth. DTMRI may operate by applying magnetic field gradients to create a 3D image that is sensitized to diffusion in a particular direction. This process is repeated across an array of gradient directions to capture three-dimensional diffusivity as a function of spatial position throughout the tissue, according to a Gaussian diffusion model. The output of DTMRI is a per-voxel 3×3 diffusion tensor, the covariance matrix of a Gaussian distribution of three-dimensional water molecule displacement. In a tissue environment, the diffusion vector is typically along the long axis of a cell. For example, in the heart, water most readily diffuses along the long axis of cardiomyocytes. As such, the major eigenvector of the diffusion tensor (primary diffusion direction) represents the average orientation of cardiomyocytes in the corresponding voxel. The primary diffusion direction within each voxel may be interpolated to effectively form an [symbol] ³→ [symbol] ³ vector field representing myofiber orientation. An algorithm may determine a DTMRI-derived myofiber orientation field to generate field-oriented toolpaths for 3D bioprinting, such that the print line architecture of the fabricated organoid matches the myofiber architecture of the native tissue. A 3D printer may, based on the toolpaths, fabricate the G-code. In some examples, the G-code may be for an acellular, silicone model of the isolated left ventricle. In other examples, the G-code may be for a human heart made of living, dormant, or other tissues. The system may perform computational volumetric coverage on the output toolpaths.

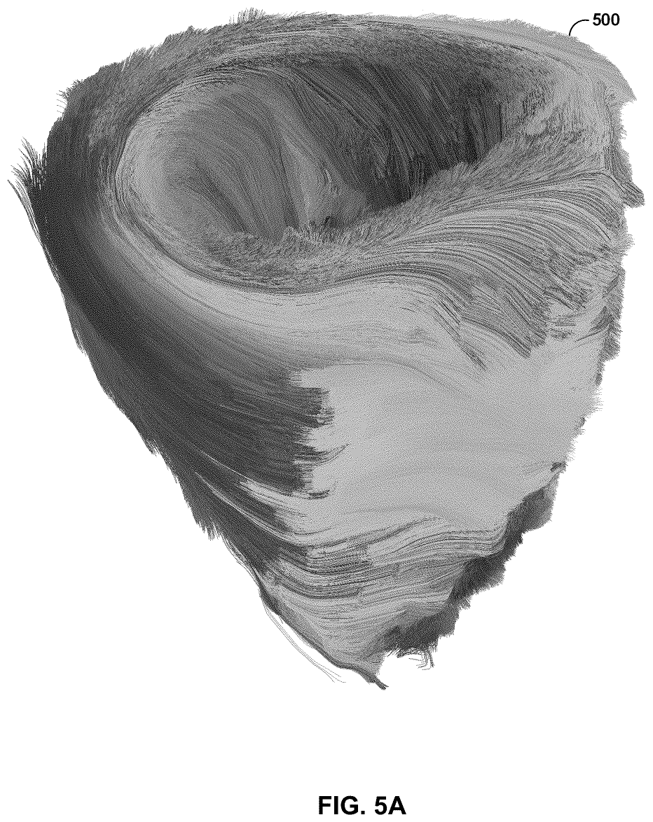

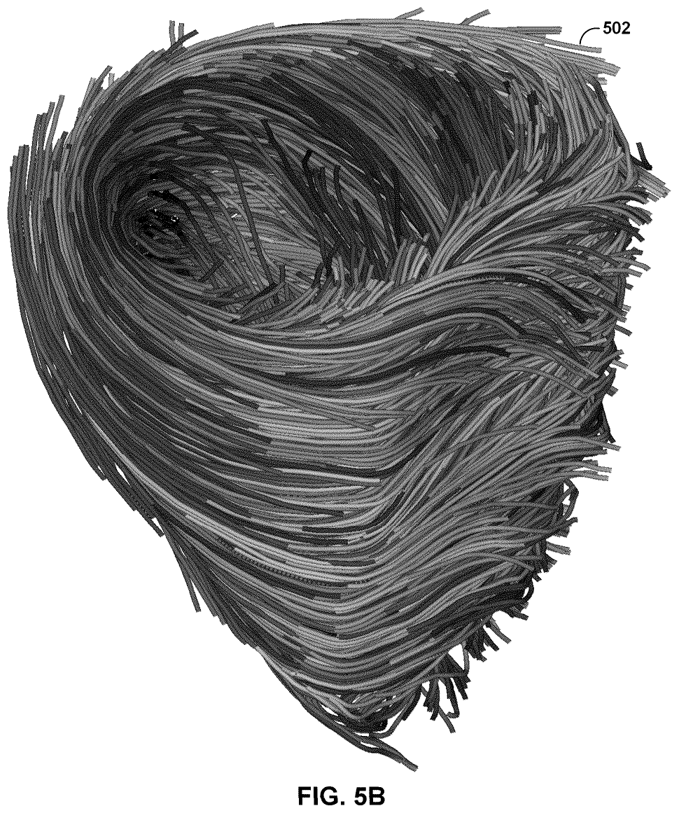

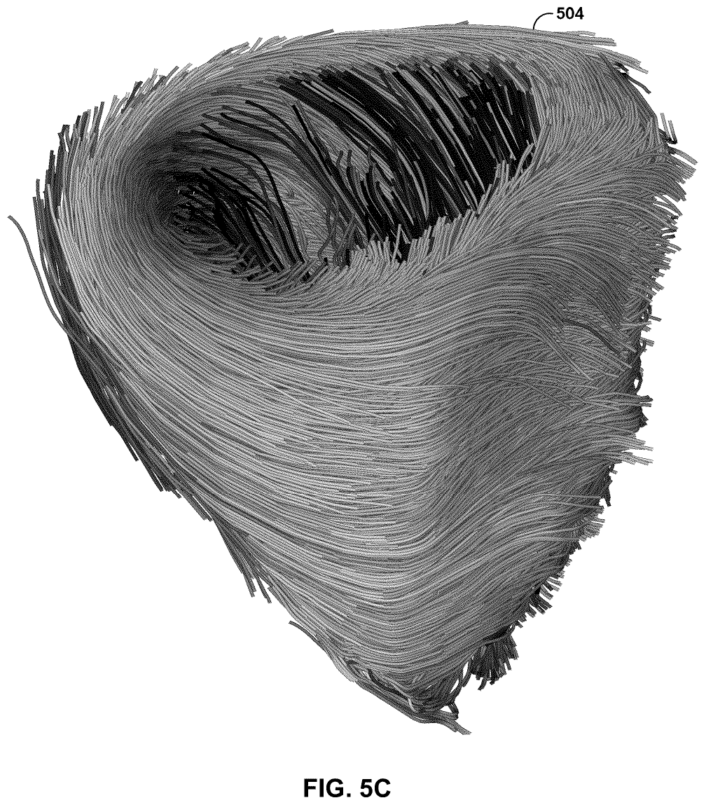

Therefore, a full DTMRI scan may contain information about the location and 3D orientation of each cell in a fibrous tissue. Software may facilitate the translation of raw DTMRI data to fiber tracts (e.g., tissue tracks) which may be continuous paths that link diffusion vectors together. This tractography process may be used for mapping tissue in biological tissues such as mapping neuron paths within the white matter of the brain, skeletal and cardiac muscle fascicles, or fibrous material in plants. DTMRI may additionally or alternatively measure diffusion tracts in any other abiotic objects or materials. The tractography of the left ventricle of a healthy human heart may be generated from raw DTMRI data (e.g., FIG. 5C described herein below). DTMRI is therefore a clinically relevant imaging modality that is capable of generating a complete rendering of fiber paths in volume.

Using preprocessed tissue tractography data generated from DTMRI, the system may convert fiber orientation data to 3D printable G-code. The example algorithm described herein produces a set of toolpaths for a 3D printer to follow in recreating the fibers, such that there is no interference in 3D space during material deposition. In this manner, the system may generate an entire volume of tissue tractography that may converted to G-code in an autonomous fashion. Certain considerations factored into this process include: exporting the vector and point data of each tract in a computationally-friendly way; partitioning fibers by orientation and position to create non-planar “pseudo-layers” that organize the resultant tracts and facilitate better printing quality, reducing fiber bundles in the volume equivalent to the diameter of the printing nozzle to a single, representative, fiber; slicing fiber bundles in non-planar geometries; identifying optimal printing paths for fiber bundle connectivity; maximizing the number of printing paths possible in 3D space; and avoiding path interference in 3D space. In some examples, “partitioning” may be referred to as “binning.” The result of this process is an ability of a system to not only 3D print the gross anatomical structures (e.g., tissue constructs) corresponding to the tissue structure from which the MRI scan was generated, but to do so in a way that imparts physiological cellular alignment within the tissue. In this manner, the resulting tissue constructs may include important structure-function relationships of biology in the engineered tissues.

One example tissue construct that may be created using the toolpath generation method described herein is a gastroesophageal junction (GEJ). Cancer of the gastrointestinal system, such as gastroesophageal adenocarcinoma, is a significant source of morbidity and mortality, with an estimated 200,000 new cases in the United States in 2019. For cancers involving the alimentary canal (e.g., esophagus, stomach, intestines), surgical resection of the cancer and anastomosis of the cancer-free portions of the tube is the best treatment if the tumor is small. The GEJ may be treated in this manner with a surgery known as gastric pull-up; however, patients may experience complications after the procedure. Loss of the GEJ's anatomical barrier to reflux may lead to pulmonary complications. Thus, while simple resection and anastomosis is attractive in some regions of the alimentary canal, there is an urgent need for new solutions at the GEJ. Recent developments in induced pluripotent stem cells raise the possibility that patient-specific autografts may be tissue-engineered. Clinical trials have successfully replaced portions of the esophagus with tissue-engineered products. Despite these apparent successes, almost no work has been done to rebuild the GEJ which at least in part may be due to anatomical complexity of the muscles structure and the need for vascularization. As described herein, pre-aligned microtissues and toolpath generation for fiber placement in 3D printing of larger tissue constructs may enable the creation of various anatomical structures, such as the GEJ. 3D printing of pre-aligned microtissues may enable the creation of any other tissue in other examples.

Generally, the microtissues and tissue constructs described herein may be mammalian cells (human or non-human). In other examples, the techniques described herein may also be performed using non-mammalian cells, such as plant cells, or scaffold materials such as extracellular matrix proteins. In some examples, plant cells may be configured to generate various constructs suitable for pharmaceuticals and/or delivery of pharmaceuticals. The techniques described herein may additionally be applied to non-tissue constructs. A non-tissue construct may include reproducing a DTMRI scan of tissue via a soft material or polymer. For example, the techniques described herein may be applied to acquire, analyze, and improve a DTMRI scan of tissue and thereafter print the scanned tissue as a silicone model where the silicone model may be configured to be an organ modelling or surgical planning instrument. The silicone model may be formed of 3D printed silicone, or a silicone-like elastomer such as Silicone 40A Resin manufactured by Formlabs of Sommerville, Massachusetts. The non-tissue constructs may alternatively be formed of Thermoplastic Polyurethane (TPU), Thermoplastic Elastomer (TPE), Elastomers, Hydrogels, Elastomers, Shape Memory Polymers, or Photocurable Soft Materials. Any one or more of these materials or any other suitable 3D printing material may be deposited by any suitable 3D printing technology such as inkjet printing, binder jetting, selective laser sintering (SLS), stereolithography (SLA), fused deposition modeling (FDM) and semi-solid extrusion. In some examples, the non-tissue constructs may include industrial applications such as liquid crystal analysis, rocket booster analysis, and/or concrete analysis. Although the techniques described herein are generally described for biological tissue, the same toolpath determination and G-code (or other printing computer code) can be applied to any type of material deposition that may be non-biological (e.g., polymers, slurries, gels, or other materials).

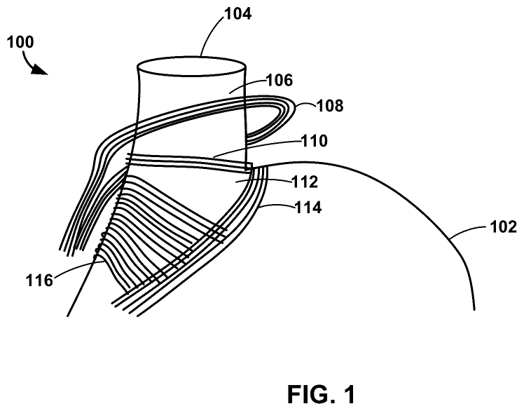

FIG. 1 is a graphical representation of an example gastroesophageal junction (GEJ) 100 fascicle arrangement between stomach 102 and esophagus 104 in accordance with the examples of this disclosure. GEJ 100 includes a thick inner circular muscle layer of the esophagus continuous with bundles of smooth muscle. GEJ 100 differs from the rest of the alimentary canal in its complex arrangement of smooth muscle bundles.

GEJ 100 includes muscles, ligaments, and tendons which are configured to constrict and thereby may separate the acids of stomach 102 from esophagus 104, forming an anti-reflux barrier. GEJ 100 may be exposed to the injurious effects of gastroesophageal reflux disease (GERD) and/or Helicobacter pylori infections. The injurious effects of GERD and/or H. pylori infections, along with other risk factors such as obesity and genetics, may increase a frequency of cancer, which may be treated by removing tissue from GEJ 100. Having a compatible replacement GEJ 100 would mitigate some potential side effects of this surgery, but GEJ 100 has a complex anatomy and therefore an improved replacement GEJ 100 may be desirable.

GEJ 100 is a complex of overlapping structures which include muscles, ligaments, and tendons. GEJ includes pharyngoesophageal ligament 106, right crus fibers 108, lower esophageal control sphincter (LECS) 110, gastroesophageal flap valve 112, sling fibers 114, and clasp fibers 116.

Pharyngoesophageal ligament 106 of GEJ 100 is the ligament which attaches the esophagus to the diaphragm. Right crus fibers 108 are tendinous structures that extend below the diaphragm to the vertebral column. Lower esophageal control sphincter (LECS) 110 surrounds the lower part of the esophagus at the junction between the esophagus and the stomach. Gastroesophageal flap valve 112 is a 180-degree musculo-mucosal fold opposite to the lesser curvature of stomach and is created by an intraluminal extension of His angle. Sling fibers 114 are long oblique smooth muscle fibers extending from on the great curvature of the cardia. Clasp fibers 116 are short semicircular smooth muscle fibers on the lesser curvature of the cardia. Sling fibers 114 and clasp fibers 116 run in parallel to the lesser curve into the gastric antrum.

At GEJ 100, there is a thickening of the inner circular muscle layer of the esophagus that is continuous with bundles of gastric sling fibers 114. Gastric sling fibers 114 are opposed by gastric clasp fibers 116 on the lesser curvature of stomach 102. The structures of GEJ 100 have specific mechanical roles and the smooth muscles of GEJ 100 contract in unison to maintain the anti-reflux barrier at GEJ 100. A feature to achieving contractile function is highly aligned gut smooth muscle cells (gSMCs) within these bundles. As described further below, printing pre-aligned microtissues into larger tissue constructs may enable creating of the GEJ 100 with highly aligned gSMCs that provide the functionality of the GEJ 100. As described herein, imaging data of a target GEJ may be processed to generate a map of the tissue tracks, determine a set of toolpaths from the map, and then generate computer code that defines 3D printing along the set of toolpaths. Other tissue structures may be scanned to enable printing of corresponding tissue constructs, such as other muscle structures (e.g., heart or skeletal muscle), connective tissue, or even other organs.

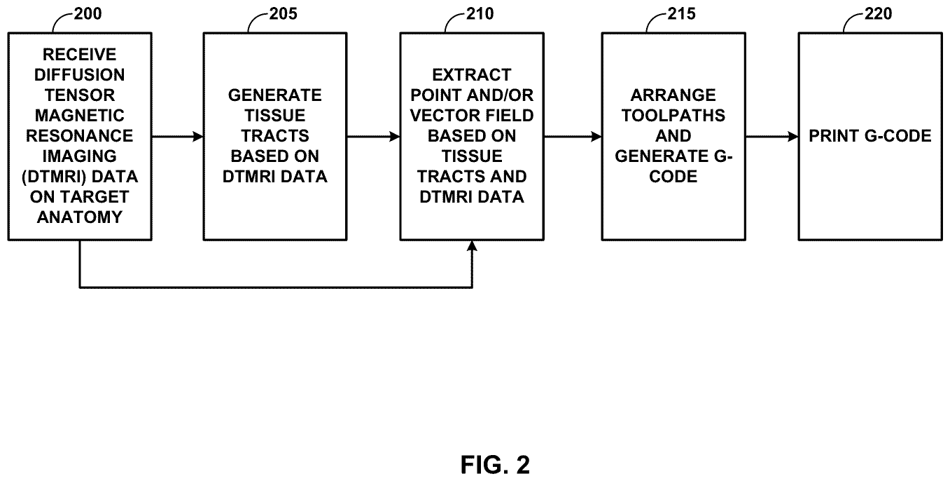

FIG. 2 is a flow diagram of an example process for determining printing paths and printing a tissue construct. As shown in the example process of FIG. 2, a target tissue, such as GEJ 100 of FIG. 1, may be selected for scanning and eventual printing. The example process of FIG. 2 may be applied to any other target tissue of the body to enable printing of corresponding tissue constructs, such as other muscle structures (e.g., heart or skeletal muscle), connective tissue, or even other organs.

First, the target tissue (e.g., the target anatomy of a patient) is scanned by a diffusion informed imaging modality, such as a diffusion tensor magnetic resonance imaging (DTMRI) machine, and the scan data from the DTMRI is sent to processing unit, such as a computer, a server, a mobile device, or any other device which may receive electronic data. The system (e.g., computer, or other electronic device) may receive the DTMRI data on the target anatomy (200) and may generate digital tissue tracts based on the DTMRI data (205) using fiber tractography. Fiber tractography measures the diffusion of water molecules in the target anatomy, such as through DTMRI, and may generate a diffusion vector for each voxel of the DTMRI data. Proximate diffusion vectors may be stitched together into a diffusion path which represents a tissue tract because water preferentially diffuses along the length of tissue. Generating toolpaths may include extracting point and/or vector fields from the DTMRI data and the generated tissue tracts (210). The system may arrange the toolpaths and generate G-code to define the toolpaths (215). The G-code may then be uploaded to a controller that operates a 3D printer for 3D printing the tissue construct using cells and/or other microtissues along the determined toolpaths defined by the G-code. The controller may operate the 3D printer to print the G-code (220) to form a reproduction of the target tissue.

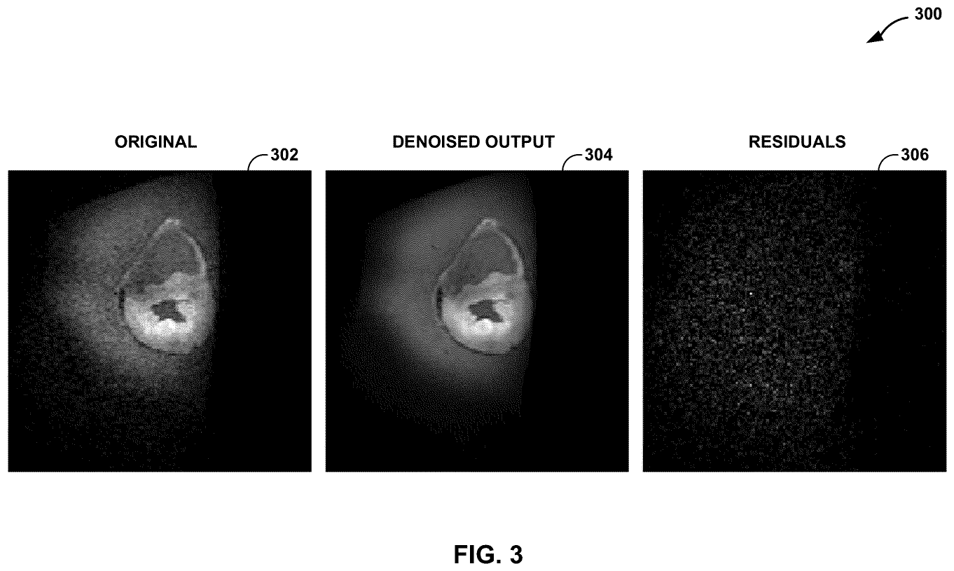

FIG. 3 includes images of example DTMRI data before processing, after processing, and the difference therebetween. In the example images of FIG. 3, the results of patch2self denoising of DTMRI data from a heart is provided. A transverse slice from the DTMRI data of a left ventricle of a heart is shown in the example of images of FIG. 3. An image before processing 302, (e.g., an original image) is shown at left of example images 300. An image and after denoising 304 is shown at center. Random noise in the residual plot 306 is shown at right and indicates that no structural data was lost during the denoising process because there is no outline of the left ventricle of the heart or other structures in residual plot 306. Residual plot 306 is the noise removed by processing (e.g., denoising) which may be caused by the instrument, movement of the patient, or other noise sources.

In order to determine the tractography of the DTMRI data, the system may convert the files. For example, raw DICOM files from DTMRI scans may be converted to NIFTI, b-value, and b-vector formats using a software package called MRIConvert, developed by the Lewis Center for Neuroimaging, University of Oregon. MRIConvert converts the data from a first file format to a second file format by altering the data encoding, metadata, and data structure from the first standard to the second standard Once converted, NIFTI, b-value, and b-vector files may be loaded into Python using functions in the DIPY library.

One of the first steps in processing DTMRI data may be a process called denoising, which removes noise in the data while preserving structural and diffusion information. DIPY includes a function for denoising called patch2self, which implements a self-supervised machine learning process to separate the structure of the imaged tissue from noise in the data, then removes the noise data without impacting structural information. The patch2self function is entirely self-contained and does not require any assumptions or models for either the structure of the tissue or the noise in the data. To confirm that the denoising was successful and that the denoising did not remove structural data, a slice of the DTMRI scan may be visualized before and after denoising. The residual plot—defined as the square root of two times the difference between the original and denoised data—is also visualized to confirm that no structural data was lost during the denoising process. This plot should appear as random noise, as is seen in residual plot 306, in a scan where denoising was successful, and therefore denoising was successful in example images 300 shown in FIG. 3.

For the example images 300 and data provided herein, heart DTMRI data was acquired using a Siemens 3T MAGNETOM Trio scanner (Siemens, USA) with a maximum gradient amplitude of 40 mT/m. Data was acquired at room temperature. Hearts were positioned to be imaged in a ventricular short axis view. Scan acquisition parameters for heart 244 were: echo time=98 ms; pulse repetition time=4000 ms; slice thickness=4 mm; slice spacing=4 mm; b value=1100 s/mm2; number of averages=1; matrix size=128×128. Scan acquisition parameters for heart 333 were: echo time=93 ms; pulse repetition time=4008 ms; slice thickness=4 mm; slice spacing=4 mm; b value=1200 s/mm2; number of averages=1; matrix size=128×128. All hearts also included a null-weighted image (b=0 s/mm2).

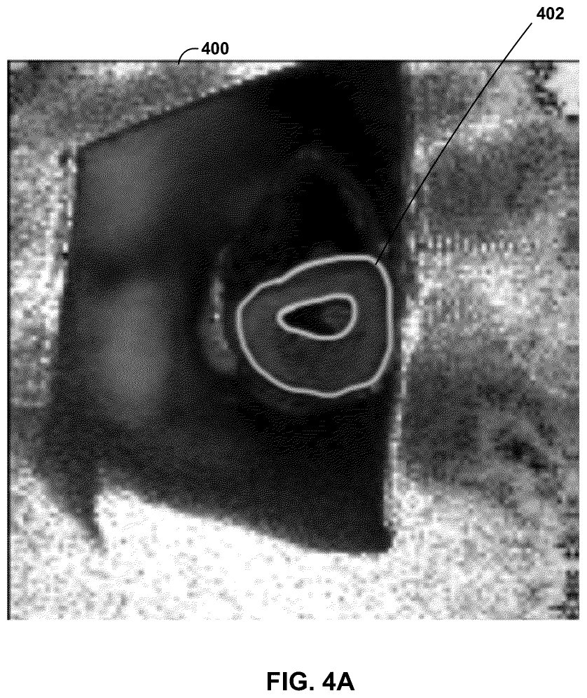

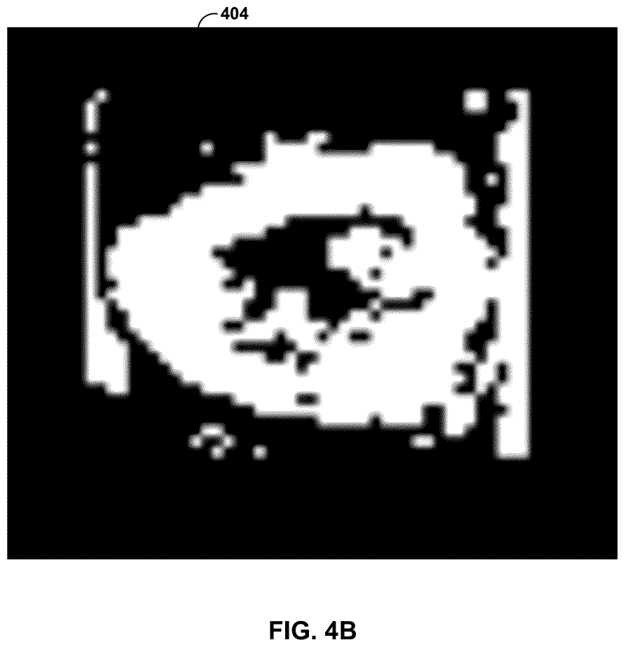

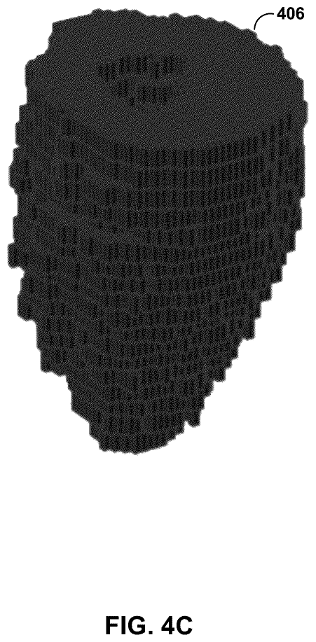

FIG. 4A is an image of example transverse slice 400 of the DTMRI data of a heart with left ventricle wall 402 outlined. Left ventricle wall 402 (the region of interest) is outlined by two circles in the image. This is the portion of the scan that should be selected by a mask. The rest of the image contains background and noise. After denoising the raw data, the next step in DTMRI analysis is creating a binary mask that identifies the region of interest for tracking. In an example case of this workflow, the region of interest is the left ventricular wall. DTMRI scans inherently contain background and noise regions, the regions which are not within the two circles in the image, which do not contain useful information for performing tractography (FIG. 4A).

There are multiple ways to mask the raw data. One possibility is using an external software to create a mask manually. Another option is using threshold masking to segment out voxels which do not show sufficient anisotropy to be considered part of the tissue. There are several metrics that may be configured to analyze voxel anisotropy, some of which may be computed from within the DIPY library. Different methods have been performed here for comparison.

To manually create a mask, an open-source software called ITK-SNAP was used. This software provides basic tools for manual image segmentation, enabling the user to select the region of interest in each slice of the 3D image. Selecting the region of interest in each slice may digitally label each voxel of the 3D image with a selected or not selected label. When all selections have been made, the mask may be exported to a NIFTI format, which may be used as a mask for further DTMRI analysis in Python.

As shown in the example masking 404 of the heart for FIG. 4B, threshold masking may be achieved within the DIPY library in Python, for example. Using this software, the generalized fractional anisotropy was calculated, which is a measure of diffusion anisotropy, at all points within the heart. Generalized fractional anisotropy values may range from 0 (totally isotropic) to 1 (maximally anisotropic). Several potential threshold values were tested, ranging from 0.05 to 0.5, to determine the target threshold for selecting the left ventricular wall. The value selected for the example shown in FIG. 4B was 0.14 but may be different in other examples based on the noise of the scan, density of the target anatomy, the location of the target anatomy, the quality of the scan, and other suitable factors which may influence a threshold value. This threshold value, along with the generalized fractional anisotropy calculation were used to select only regions of the scan where the generalized fractional anisotropy is greater than 0.14. Thresholding may be done, for example by ThresholdStoppingCriterion function in DIPY which may operate through a scalar map to stop the tracking whenever the interpolated scalar value is lower than a fixed threshold such as at an ending region (e.g., low FA, gray matter, or corticospinal fluid regions) or exits the image boundaries. ThresholdStoppingCriterion may use a trilinear interpolation at the tracking position by taking two parameters: metric_map and threshold where metric_map is an array and threshold is a float value. Tractography stops when reaching a position where metric_map at that position is less than threshold. Threshold masking does not remove all background artifacts, so the mask was manually cropped to remove any regions other than the left ventricle that were selected by the function.

There are also additional metrics for diffusion anisotropy that could be used for threshold masking, such as linear, planar, and spherical coefficients of diffusion. Each of these coefficients may range from 0 (totally isotropic) to 1 (maximal anisotropic), and sum to 1. Masking voxels by a threshold value of the sum of the linear and planar coefficients is a viable way to segment out voxels containing tissue. In this example, a threshold value of 0.09 was used for the linear-planar coefficient sum to mask the left ventricle. In other examples, any other threshold value may be used for the linear-planar coefficient sum to mask any scan data. In this example, the technique was highly effective in separating the left ventricular wall from surrounding non-tissue-containing voxels, but was not as effective in separating the ventricular septum from the rest of the heart. For this reason, the inner portion of the left ventricle was manually segmented out using ITK-SNAP, along with any background noise that remained after the initial coefficient thresholding. Manual segmentation includes manually labelling voxels as either being part of the left ventricle or not a part of the left ventricle.

Example segmentation 406 of the left ventricle is shown in FIG. 4C. Example segmentation 406 is a 3D mask of an example left ventricle of a heart which is represented by multiple layers of voxels. Each voxel occupies a length, width, and height which represents a region of heart tissue. Each layer of voxels represents a slice of the heart, of a defined thickness, from the apex to the mitral valve of the left ventricle of the heart. Together these voxels represent a shape of tissue the left ventricle of the heart. Example segmentation 406 is produced using a combination of linear-planar coefficient sum thresholding, manual masking, and manual segmentation. A linear-planar coefficient sum threshold value of 0.09 was used in the example shown in FIG. 4C.

FIG. 5A is an image of example tractography 500 for a heart. The image in FIG. 5A is an example of complete tractography results for a heart using a mask. Deterministic tractography (e.g., determining a map of the tissue tracks) may be performed in the masked region of interest, as described above. Tractography is the process of tracing a fiber (e.g., a cardiac muscle fiber, a gastroesophageal muscle fiber, a neural tract, or other tissue fiber or tissue orientation) through a volume. Example tractography 500 is an example of tractography of the left ventricular wall of the heart. In deterministic tractography, the direction of the maximum diffusion vector at each step is followed, meaning that the same tractography results will be produced each time the function is run, given the same inputs.

In some examples, tractography generally starts at points called seeds. The system may generate evenly spaced seeds throughout the masked region of interest with a fixed density (e.g., 2×2×2 seeds per voxel). In some examples, the seeds may be added using the utils_seeds_from_mask function in DIPY which may create seeds for fiber tracking from a binary mask, where the seed points are placed evenly distributed in all voxels of the mask. From each starting seed, tractography proceeds with a fixed step size (e.g., 0.5 mm). At each step, tracking proceeds in the maximum direction of the orientation distribution function (ODF) at the current point in space. The diffusion tensor within each voxel can be interpolated to yield a continuous tensor as a function of spatial position, the primary eigenvector of which describes the maximum diffusion direction of the ODF. Tracking terminates when the edge of the region of interest is reached, which may be defined as a generalized fractional anisotropy value less than a threshold being outside the masked region, or when the streamline reaches a predefined maximum length. More complex tractography techniques, such as Runge-Kutta, Dormand-Prince, and Moving Least Squares (MLS) can also be employed to yield fiber tracts from a set of seed points throughout a diffusion tensor field. In some examples, the threshold for the generalized fractional anisotropy value is 0.14. In other examples, the threshold for the generalized fractional anisotropy value may be any other suitable value. This is achieved with the LocalTracking and Streamlines functions in DIPY.

The LocalTracking function of DIPY is a method used to create streamlines from local directional information. For LocalTracking, if the local directionality of a tract/pathway segment is known, integration along those directions may build a complete representation of that structure. For example, LocalTracking may use a method for getting directions from a diffusion data set which may be achieved by fitting the data to a model that can estimate the Orientation Distribution Function (ODF) at each voxel, a method to identify when tracking must stop, and a set of seeds from which to begin tracking. The ODF represents the distribution of water diffusion as a function of direction. The peaks of an ODF are good estimates for the orientation of tract segments at a point in the image. The method for identifying when the tracking must stop may be done by setting a threshold on a scalar map (like fractional anisotropy or mean diffusivity) or on the ODF values directly. The set of seeds from which to begin tracking may be typically placed in every voxel. The LocalTracking function takes these three components and uses them to generate a set of streamlines that represent the estimated trajectories of fibers through integration of the local directional information.

Pseudo-3D visualization 502 of the fiber tractography of the left ventricle of the heart is shown in FIG. 5B. Pseudo-3D visualization 502 scheme may be achieved by using DIPY. As shown in example tractography 500 of FIG. 5A, the system was able to track (i.e., determine fiber tracts for the tissue) over the entirety of the example left ventricle. Nearly 625,000 streamlines (e.g., tissue tracks) were produced by the tracking algorithm. When attempting to visualize this extremely large number of streamlines, it is difficult to differentiate individual fibers. Therefore, for the visualization purposes to view pseudo-3D visualization 502, the system subsampled 1,500 random streamlines from the results and applied a pseudo-3D visualization scheme using DIPY.

An image of example complete tractography 504 for a left ventricle of a heart of a patient using the 3D mask of FIG. 4C is shown in FIG. 5C. Complete tractography 504 includes tracts for every region of the left ventricle of the heart and therefore the system was able to track the entirety of the left ventricle. Streamlines have been colored according to helical angle, the angle the streamlines make with the short-axis plane of the heart.

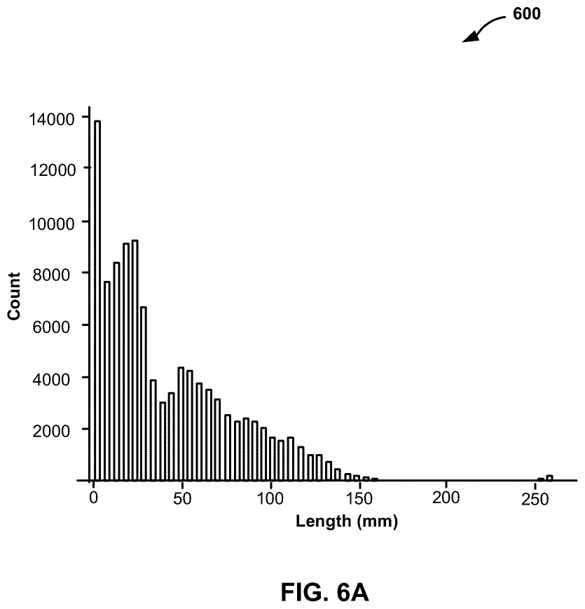

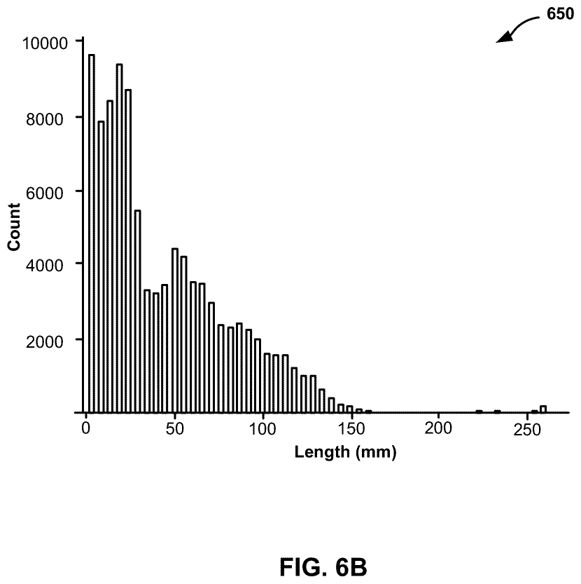

FIG. 6A is a graph of example histogram 600 of tracked streamline lengths in an example heart. FIG. 6B is a graph of example histogram 650 of tracked streamline lengths after processing. The histograms do not show the full range of streamline lengths for ease of visualization.

The system may also proceed with streamline post-processing and analysis which may improve tractography of the streamlines. The streamlines may be representative of a left ventricle of a heart. The system may prioritize the length and the logicality of the streamlines. In some examples, the system may calculate or determine the length of each streamline generated during tracking. For example, the length function in DIPY may be configured to calculate the length of each streamline generated during tracking. Of the nearly 625,000 streamlines identified by the tracking algorithm, the majority were less than 2 mm in length, as shown in FIGS. 5A and 5B and as indicated in the histogram of FIG. 6A. Removing streamlines less than 2 mm in length, as indicated in the histogram of FIG. 6B, improves the quality of the tractography.

Additionally, removing illogical streamlines-streamlines that do not follow the trend of streamlines around them-increases the accuracy of the tracking results. This is achieved by the system implementing the cluster_confidence function in DIPY. cluster_confidence is an outlier scoring method used in streamline analysis and compares the pathways of each streamline in a defined bundle pairwise and scores each streamline based on how many other streamlines in the bundle have similar pathways. Cluster_confidence may exclude short streamlines, such as streamlines with a length of less than 40 mm, such that cluster confidence score is not inflated by short lines. Streamlines with low cluster confidence scores are trimmed from the tracking results. The cluster confidence score may have a threshold confidence level applied where all streamlines with a cluster confidence below the threshold are removed and the streamlines above the threshold are kept. Removing streamlines with low cluster confidence increases the likelihood of anatomically accurate tracking. In this manner, the map of tissue tracks may be altered as needed when processing to determine the one or more toolpaths. As shown in FIG. 6B, reducing the very short streamlines may increase the relative population of longer streamlines. The streamlines post-processing (i.e., the streamlines from the original tractography after removing the shortest and low cluster confidence streamlines) may be used as the one or more toolpaths that may define printing of cells or microtissues of one or more cells.

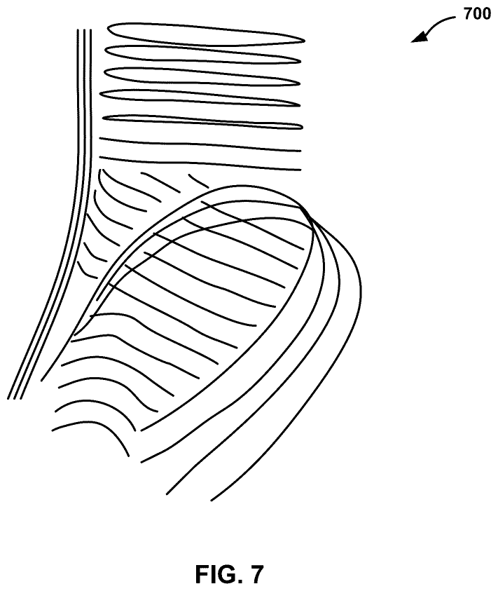

FIG. 7 is a diagram of example toolpaths for printing the GEJ of FIG. 1. In the example of the GEJ of FIG. 1, one or more toolpaths 700 may be generated from the map of tissue tracks. G-code is an example of computer code that may then define the toolpaths. As simulated in ideaMaker slicing software, the system may be configured to convert from an input of a set of coordinates to a functional G-code file. Slicing is a type of software that is configured to transform a 3D model into specific instructions for 3D printers by slicing the 3D model into layers and produce a G-code file that the 3D printer may use to print. Slicing may include translating a first data type into a second data type, where the second data type is G-code.

GEJ is just one example of a proof of concept. FIG. 7 is a diagram of numerous paths which illustrates the gastro-esophageal junction (GEJ) anatomy. The diagram is based on a graphic produced in Blender (an open-source 3D graphics software) and processed with a Python application built into the Blender program. Drawn paths from this rendering were used in lieu of real tractography data to show proof of concept. Coordinate points at nodes along these paths were extracted and written to a series of .csv files, with each path being represented by a single .csv file. A second Python script may order the paths and convert them to a series of G-code commands that could be interpreted by a 3D bioprinter. This script scanned its own directory to find any .csv path files and converted the contained coordinates into G-code toolpaths. An assumption was made that the 3D bioprinting process would be performed in a support bath, providing for non-planar deposition of material. The system may be configured to select and/or order toolpaths to print from the bottom up and inside out, or any other directionality of printing, to avoid disruption of previously printed material. The system may use various system printing constraints to determine how to order the toolpaths. For example, each path may include a vertical plunge into the support bath as a first step and a vertical retraction from the support bath as a final step of the path before moving to begin the next path. In some examples, a user may input specified parameters like nozzle size, path diameter, and scaling factor. In some examples, the system may, before writing the G-code, analyze all the available paths to find global bounds, enabling the print to be automatically situated at a safe position in the support bath (not too high or low, and centered within the bath). These processes produce translation vectors that could be applied to all curves prior to conversion to G-code. Each path may be represented by a .csv and is processed into G-code and written to a single output file which may be a .gcode file. The toolpaths from this file were simulated using ideaMaker slicing software and outlined as shown in FIG. 7.

In the example of the heart as a target tissue structure, the first step in generating printable toolpaths for the heart may be smoothing streamline coordinate data (e.g., the map of tissue tracks) which removes small perturbations in the path that are inconsequential in the final printed product. Once the toolpaths are smoothed, there are a number of possible ways to determine which streamlines to use for toolpath generation. One option is to calculate the distance between streamlines, then sequentially eliminate streamlines until a target distance between the streamlines is met. In this method, streamlines are analyzed locally to determine an average distance between each streamline and a number N (e.g., N may be 5, 10, 15, or any other number of neighbors) of its neighbors, as well as the average of those distances. The average of these distances is an average inter-streamline distance metric. Using the average inter-streamline distance metric, streamlines may be recursively trimmed from the data set to meet a target average inter-streamline distance. The target distance is set by physical limitations of the printing system, such as nozzle diameter and suitable spacing between printed paths. After each round of streamline trimming, calculations may be rerun and the metrics may be compared to the target again. This process repeats until a satisfactory solution has been found that produces a set of streamlines at the target spacing, with even dispersion throughout the volume of the left ventricular wall. In other words, the system may determine the average distance between streamlines from a reference streamline. If the average distance metric is smaller than a printing capability, the closest streamline may be eliminated and the process may be repeated until the average distance metric of the reference streamline is too small. Due to the high density of streamlines in the full tractography results from the heart and the increasing resolution of MRI technology, it is possible that average inter-streamline distance would not exceed the target metric in the raw data. The system may consider metrics in addition to the average inter-streamline distance metric. Standard deviation of streamline spacing may be followed to ensure that streamline spacing—and, eventually, toolpath spacing—is as consistent as possible.

The number of ways this selection of streamlines may be processed is large and based on the number of streamlines, the distance between the streamlines, and the suitable distance between the streamlines. Other possible streamline processing algorithms include: a random selection of a target number of streamlines; selecting every N^{th} streamline; using metrics other than distance between streamlines, for example streamline density, to select streamlines; eliminating all streamlines with less than a threshold distance between themselves and their closest neighbors; eliminating all streamlines that cross or interfere with another streamline. Random selection of a target number of streamlines may include a selection of a random number, or a predefined number which is the number of streamlines selected. Based on the target number of streamlines, streamlines may be selected at random based on a random number generator as reference streamlines from which the above described streamline optimization and remove will be performed. Selecting every Nth streamline may provide for a selection of a streamline every N streamlines in order, where N is a number randomly chosen for chosen by a user and the order may be predefined by a user or defined by a rule such as length, position, or cluster confidence. Streamline density may be a metric based on the number of streamlines passing through defined voxels which defines streamline density for that voxel. Voxels over a pre-determined density are selected for thinning of streamlines which may be repeated recursively with differing and suitable voxel sizes or thresholds.

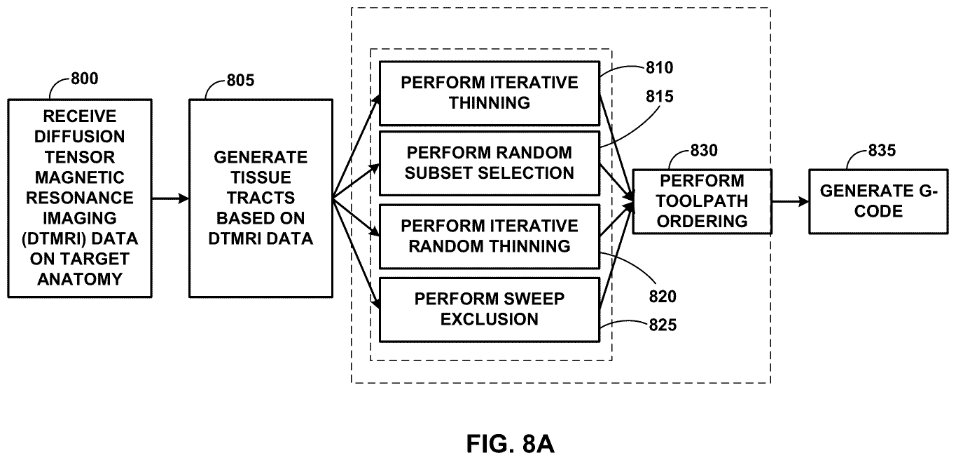

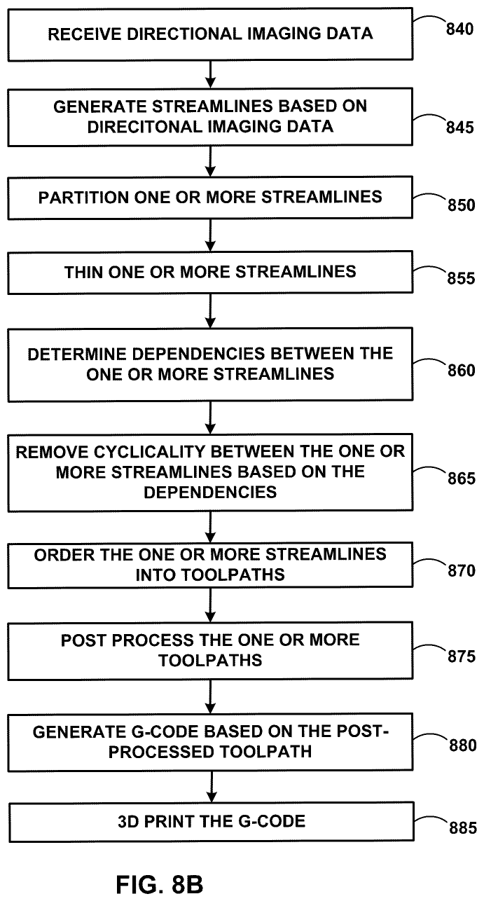

Another technique for selecting a streamline subset may be to iteratively select a streamline of interest, remove all other streamlines that are sufficiently proximate the streamline of interest at any point, select a new streamline of interest using some comparative metric, and repeat the process until all remaining streamlines have been selected. A swept cylinder can be created with the streamline of interest as its central axis, and all other streamlines that interfere with this cylinder can be removed. When selecting the next remaining streamline to sweep, the inter-streamline distance to the previously swept streamline can be minimally selected for, to yield a reduced streamline set containing densely packed streamlines. Inter-streamline distance can, for example, be defined as the piecewise-average distance between the point sequence defining two streamlines. Eliminating all streamlines that interfere with another streamline may include defining a distance around each streamline and determining intersections based on an overlap of the regions surrounding each streamline such as a sweep exclusion method as described below with regard to thinning one or more streamlines 855 of FIG. 8B.

Manual supervision, or manual correction, may be implemented. With manual supervision a user may control which streamlines are kept, and which streamlines are removed, such as via a user interface. Raw streamline coordinates may not serve the purpose of toolpath generation in some examples, for example, being extremely convoluted or intersecting, in which case idealized streamlines may be generated from averaged directionality data of a cluster of streamlines.

After toolpaths have been generated from streamline data, the toolpaths may be ordered. Toolpaths may be ordered to enable 3D printing system to deposit material (e.g., cells or microstructures) in an additive fashion in 3-dimensional space. The printing process should not interfere with previously deposited material and enable the 3D printer to reach all points in space where material is deposited. Additionally, to decrease the time it takes to complete the printing process, non-extruding travel distance may be minimized. Based on the geometry and fiber orientation of the left ventricle, the optimal printing orientation may resemble an inverted cone, so that toolpaths may be ordered from inside out and bottom up.

An algorithm may, after each completed print line, identify the subset of printable lines, and select the closest printable line to print next. The subset of printable lines is defined as any line that has not yet been deposited and is not above any other unprinted line. Specifically if the current line is above an unprinted line, the current line would not yet have support and/or would interfere with deposition of the unprinted line (i.e., would block the deposition of material there.) Determining whether a line is “printable” depends on the shape and size of the extruder (e.g., the size of the printing nozzle) configured to deposit material, the shape being extruded, the size and shape of the print bed, as well as any other fact which may be relevant to 3D printability. Within the subset of printable lines, the closest endpoint is the one which minimizes travel in 3D space between the current position of the toolhead and the beginning of the next deposition path. In effect, this process consists of a greedy search, where the search space at each step in the search is the set of unprinted toolpaths that are printable.

In 3-dimensional space, a solution to this toolpath ordering problem is not guaranteed. In some examples, helical toolpaths create cyclic dependencies. A cyclic dependency may be a toolpath where a first toolpath depends on a second toolpath and the second toolpath, through any number of intermediary toolpaths, depends on the first toolpath, creating a dependency loop. For example, consider two intertwined helical toolpaths-they may “crossover” each other at many points, such that after printing one of the helical toolpaths, another toolpath may not be printed without obstructing the initial toolpath as the initial toolpath is axially above the next tool path. Cyclic dependencies are of particular concern to printing the left ventricle, as the left ventricle may be formed of intertwined helical toolpaths, due to the fiber structure of the left ventricle. The system may employ, as part of the algorithm, a process to add a “seam” to the left ventricle, which may remove the cyclic dependency and enable a solution to the toolpath ordering. This “seam” may be represented by a planar surface perpendicular to the XY plane that intersects the left ventricle wall at the interventricular septum, where all toolpaths that intersect the plane are “cut” at the intersection point. This largely mitigates the intertwined helical toolpath problem, by ensuring that a single toolpath may not travel more than one rotation around the ventricle. As with toolpath generation, it is possible that manual supervision of the algorithm may be necessary to find a practical and printable solution. As described above with regard to toolpath generation, manual supervision may include a user interface where a user may selectively add one or more seams, or add/remove one or more streamlines, to improve the printability or remove a cyclic dependency.

During the ordering process, one or more streamlines that lead to high interference may be removed from the toolpath set. One or more streamlines may be iteratively removed until a printable set of toolpaths is obtained. A metric may be assigned to each streamline that corresponds to the interference that streamline imparts on the toolpath set, and the streamline in the toolpath set with the largest value of this metric can be iteratively removed until the toolpath set is printable.

Alternatively, there are other possible methods that might be implemented for handling the order of toolpaths, including: using a different orientation of the printed object; using top down or outside in approaches; opting to not minimize print time and/or non-extruding travel; generating a subset of many possible toolpath sequences and selecting from that subset based on predefined criteria; implementing an alternative to the “seam” methodology for non-interference in 3D; using search algorithms other than a greedy search. It is possible to define the subset of printable lines differently in other examples. For example, a system might select lines that are at a certain angle, contained in a certain plane, or other subsets to generate the pool for printing.

In some examples, using a different orientation of the printed object obviates the need for a seam as the cyclicality is introduced by the print orientation. The print orientation may be selected automatically by an algorithm which selectively tries each orientation from a range of orientations and tests for cyclicality. Alternatively, the print orientation may be selected manually by a user at a user interface. A top-down printing approach may involve printing from the top to the bottom, i.e., printing from a first axial end to a second axial end by using a print head which is at an orientation which enables top-down printing. An outside in printing approach may involve printing from an outside to an inside, i.e., from a radially distal point to a radially proximate point by using a print head which is at an orientation which enables outside in printing. In some examples, the minimization algorithm, which may use a greedy algorithm to find the closest path to print next, is adjusted to select the next toolpath based on the toolpath with the fewest dependent toolpaths and/or the toolpath which provides the most support to other toolpaths. Altering the minimization algorithm to optimize based on toolpath dependencies may increase a print time, but may improve printability, may decrease the number of seams, and/or may reduce or remove manual interventions. In some examples, the algorithm may generate a first set of toolpaths and a second set of toolpaths and compare the first set of toolpaths to the second set of toolpaths. In an example, the minimization algorithm may optimize for the fewest dependent toolpaths for the first set of toolpaths whereas for the second set of toolpaths, the minimization algorithm may optimize for the fastest printing time. In other examples, the minimization algorithm for the first and second toolpaths may optimize for any factor or any set of factors. The comparison of the first set of toolpaths to the second set of toolpaths may be based on any set of criteria, including the cyclicality of the first and set, the print time of the first and second set, or any other criteria.

FIG. 8A is a flowchart of an example first technique for converting directional imaging data to G-code for instructing toolpaths for printing. In the example of FIG. 8A, multiple possible streamline or tissue track selection criteria are illustrated for generating toolpaths from the map of the tissue tracks in the tractography. Multiple potential methods for streamline, or tissue track, subset selection are listed.

First, a system receives diffusion tensor magnetic resonance imaging (DTMRI) data on the target anatomy (800). The target anatomy may be any tissue region of a patient. The patient may be a human patient. In some examples, the patient may be a non-human patient. In some examples, the tissue region is an area of complex anatomy, such as overlapping tissue which includes divergent directionality. In some examples, the tissue region may be any region of a body of the patient which has smooth muscle, tendons, or other tissues. After the system has received the DTMRI data, the system may generate tissue tracts based on the DTMRI data (805). The tissue tracts may be a matrix of vectors which indicate a direction of diffusion for the tissue represented by each of the voxels of the target anatomy. In some examples, the tissue tracts are tissue paths which are vectors stitched together into a single tissue path.

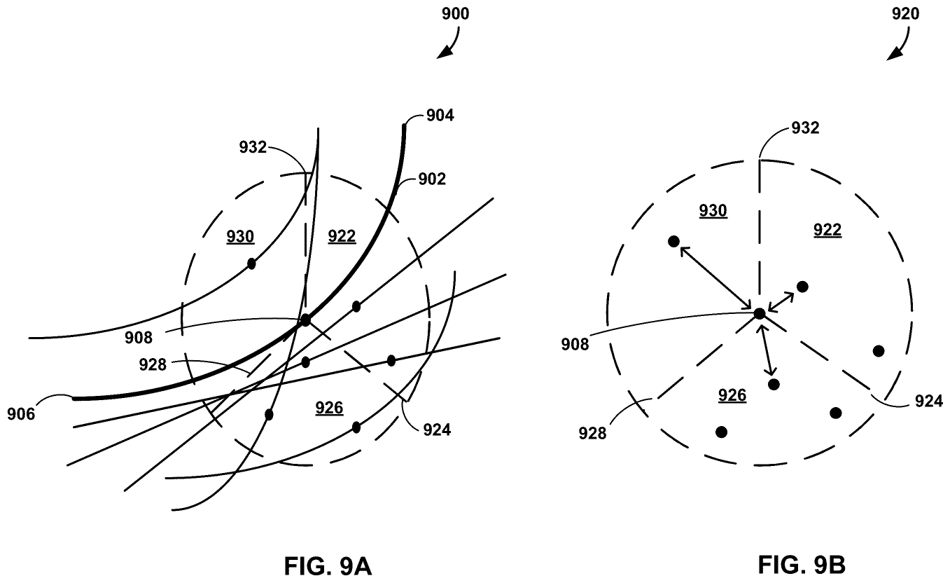

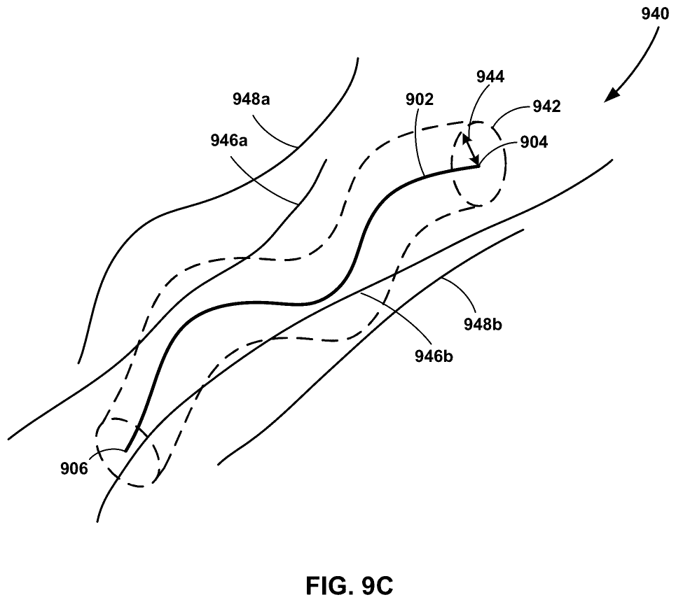

The example streamline-to-toolpath conversion algorithm of FIG. 8 consists of two main steps: first, a subset of the tractography-generated streamline set (e.g., the map of tissue tracks) may be selected to be used as printing toolpaths (810-825). The streamline subset may be selected based performing iterative thinning (810), performing random subset selection (815), performing iterative random thinning (820), and/or performing sweep exclusion (825). Iterative thinning (810) includes iteratively removing the densest streamline (streamline with the smallest spacing) until the streamline set has a suitable average spacing between streamlines. Random subset selection (815) includes generating random streamline subsets until a subset with the suitable spacing is found. Iterative random thinning (820) includes iteratively removing a random streamline until the streamline set has a suitable average spacing. Sweep exclusion (825), as shown in the example of FIG. 9C below, may include “sweeping” a cylinder of a particular diameter along a given streamline and removing (or excluding) all other streamlines that intersect with this cylinder, and repeating this process for all non-removed streamlines. The process for selecting the next streamline to sweep may be done randomly or based on a metric defining inter-streamline distance with the previously swept streamline (such as the piecewise-average distance between the point sequence defining two streamlines). This sweeping process can be repeated until, for each streamline, no other streamlines intersect its bounding cylinder. A combination of two or more streamline selection algorithms may be configured to select the subset of streamlines. For example, a random subset may be selected (815) and sweep exclusion (825) could be performed on that random subset to yield a selected subset. In some examples, it is suitable for the streamline subset to have uniform spacing in 3D space.

Once a subset of streamlines has been selected for use as a toolpath set, the second main step is that the toolpaths may be sequentially ordered such that the resulting toolpath sequence is “printable” (830). “Printable” may mean that the 3D toolpaths are ordered such that after each toolpath is deposited, the deposited tool path does not obstruct the printing of another toolpath. The toolpaths may be arranged to minimize the total printing time. Algorithms to minimize the total printing time may optimize to reduce the non-extruding travel distance. To reduce the non-extruding travel distance, each selected toolpath of the subset of toolpaths may be compared for proximity to the other toolpaths. In some examples, a system may determine a difference between the locations of each end point of a first toolpath and each end point of each of the toolpaths of the subset of toolpaths. The subset of streamlines may additionally or alternatively be selected for other reasons, such as the width of each printed material from the print nozzle, expected changes in size of the printed cells post-printing, or even to correct one or more streamlines from the imaged structure. Although generally the selection of streamlines, or tissue tracks, is described as removing one or more streamlines to generate a subset of streamlines to use as the toolpaths, the system may, in some examples, add or move one or more streamlines in order to create the suitable toolpaths and tissue construct.

FIG. 8B is a flowchart of an example second technique for converting directional imaging data to G-code for instructing toolpaths for printing. In the example of FIG. 8B, multiple possible streamline or tissue track selection criteria are illustrated for generating toolpaths from the map of the tissue tracks in the tractography. Multiple potential methods for streamline, or tissue track, subset selection are listed.

In the example of FIG. 8B, processing circuitry of a device or system may be configured to receive directional imaging data (840). In an example, the directional imaging data may include raw DTMRI data which is segmented using a two-step process to yield the isolated left ventricle volume M. The processing circuitry may be configured to generate streamlines based on the directional imaging data (845). A path integration, such as deterministic tractography may generate an initial, highly dense set of 3D contours (referred to as “streamlines” or “tissue tracts”) by integrating a direction field, e₁(x), within the voxel mask M. A processor may be configured to partition one or more streamlines (850). An initial dense streamline set S may be partitioned into a sequence of N subsets {Sᵢ}₁^{N} that are grouped for sequential printing. These subsets may be “pseudolayers” which may be concentric and stacked vertically. Concentric and vertically stacked layers have a natural printing order. These pseudolayers serve a similar purpose to planar layers in traditional printing (i.e., sequentially printing each layer in whole before proceeding to the next layer) but are not confined to planar geometries.

Processing circuitry may be configured to thin one or more streamlines (855). Each partition Sᵢ may be reduced through a series of operations, ultimately yielding an ordered sequence of streamlines Tᵢ for each partition, which may be used directly as toolpaths. “Sweep exclusion,” which is an example of a streamline thinning procedure, may reduce each partition to a preliminary representative subset (Sᵢ)_{thinned}. (Sᵢ)_{thinned} may have a spatially uniform material density. Processing circuitry may be configured to determine dependencies between the one or more streamlines (860). A directed dependency graph Gᵢ with vertices representing streamlines in (Sᵢ)_{thinned} (such that V(Gᵢ)=(Sᵢ)_{thinned}) may define ordering restrictions between all pairs of streamlines [symbol] Cⱼ, Cₖ [symbol] in (Sᵢ)_{thinned}. Processing circuitry may be configured to remove cyclicality between the one or more streamlines in (Sᵢ)_{thinned} based on the dependencies Gᵢ (865). An acyclic subgraph may be selected from each Gᵢ, such that an orderable sequence of streamlines exists. A processor may be configured to order the one or more streamlines into toolpaths (870). Greedy search may be configured to order the streamlines represented in each vertex set V(Gᵢ) acyclic, yielding a sequence of directed toolpaths Tᵢ with minimal non-extruding travel distances between each vertex of the streamlines. The representative toolpath sequence Tᵢ for each partition may be concatenated into a toolpath sequence T=\hat{T}₁ \hat{T}₂ . . . . T_{N}. Toolpath sequence T may define a toolpath to form an entire target structure (e.g., a left ventricle model) defined by M.

Processing circuitry may be configured to post process the one or more toolpaths (875). Toolpaths in T which directly interfere along each pseudolayer border may be removed from the sequence. Processing circuitry may be configured to generate G-code based on the post-processed toolpath (875). The final toolpath sequence is translated to G-code. A 3D printer may be configured to print the G-code (880). In some examples, the G-Code may be fed to a 3D bioprinter to fabricate a fiber-oriented model of the isolated left ventricle.

Receiving diffusion tensor magnetic resonance imaging (DTMRI) for target anatomy (840) may be an example of a system receiving diffusion tensor magnetic resonance imaging (DTMRI) data on the target anatomy (800) of FIG. 8A. Generating tissue tracts based on DTMRI data (845) may be an example of the system generating tissue tracts based on the DTMRI data (805) of FIG. 8A. Thinning one or more toolpaths (855) may be an example of performing sweep exclusion (825) of FIG. 8A, but in other examples may additionally or alternatively include performing iterative thinning (810), performing random subset selection (815), or performing iterative random thinning (820) each of FIG. 8A. In some examples, ordering the one or more toolpaths (870) is equivalent to sequentially ordering the toolpaths such that the resulting toolpath sequence is “printable” (830) of FIG. 8A.

Receiving directional imaging data (840) includes receiving imaging data from a directional imaging modality which may detect or otherwise measure preferred diffusion vectors for one or more voxels of the imaging data. The imaging data may include diffusion tensor magnetic resonance imaging (DTMRI) for a target anatomy of a patient. The directional imaging data may include raw DTMRI data which may be segmented using a two-step process, as described below, to yield volume M. The inputs may be a binary voxel mask segmentation M defining the boundary surface of the left ventricle and a fiber orientation field e₁(x), defined by the set of the primary diffusion direction vectors within each voxel. Input scans may be resampled. In some examples, the input scans may be resampled to an isotropic voxel size (e.g., 0.8×0.8×0.8 mm) which may increase model fidelity. Resampling may simplify or improve tractographical procedures because isotropic input data simplifies trilinear interpolation of the primary diffusion direction in each voxel. In other examples, interpolation of the primary diffusion direction in each voxel may be performed on anisotropic input data.

Binary voxel mask M, which may define a boundary surface of the DTMRI data may be segmented from the raw DTMRI scan volume using a two-stage process. First, voxels may be filtered out based on the sum of the linear and planar diffusivities of the diffusion tensor in each voxel. Next, the filtered mask may be refined to yield a coherent final mask. Linear (cₗ) and planar (cₚ) diffusivities are given by:

$$\begin{matrix}{c}_{l} = \frac{{λ}_{1} - {λ}_{2}}{{λ}_{1} + {λ}_{2} + {λ}_{3}} & ( 1 ) \\ {c}_{p} = \frac{2 ( {λ}_{2} - {λ}_{3} )}{{λ}_{1} + {λ}_{2} + {λ}_{3}} & ( 2 )\end{matrix}$$

where λ₁, λ₂, and λ₃ are the primary, secondary, and tertiary eigenvalues of the diffusion tensor, respectively.

High linear diffusivity corresponds to tissue with diffusion primarily along a single direction, and high planar diffusivity corresponds to tissue with diffusion primarily along two directions. In the example of cardiac tissue, the left ventricle is composed of muscle fibers (high λ₁) organized into sheets (high λ₂), rendering the sum of linear and planar diffusivities an effective metric for identifying tissue-containing voxels. The sum of linear and planar diffusivity is given by:

$$\begin{matrix}{c}_{muscle} = {c}_{l} + {c}_{p} & ( 3 ) \\ {c}_{muscle} = \frac{{λ}_{1} - {λ}_{2}}{{λ}_{1} + {λ}_{2} + {λ}_{3}} + \frac{2 ( {λ}_{2} - {λ}_{3} )}{{λ}_{1} + {λ}_{2} + {λ}_{3}} = \frac{{λ}_{1} {λ}_{2} - 2 {λ}_{3}}{{λ}_{1} + {λ}_{2} + {λ}_{3}} & ( 4 )\end{matrix}$$

Voxels exhibiting low c_{muscle} may be removed based on a threshold value. The threshold value may be determined by conducting a parameter sweep and selecting the threshold based on properties of M. Extraneous voxels may be removed using a segmentation software, such as ITK Snap. Such segmentation software provides for the modification of individual voxels. In the example of cardiac tissue, the inner surface of the ventricle may be manually smoothed to minimize the presence of trabeculations and the right ventricular insertion point. A singularity point in the fiber orientation field near the apex of the left ventricle may be smoothed out.

After receiving the directional imaging data, processing circuitry may generate streamlines based on the directional imaging data (845). In an example, the primary diffusion direction across all voxels of a DTMRI scan represents a discrete vector field that may be integrated to form streamlines which are continuous paths in 3D space that represent the direction of diffusion of water molecules. In the example where DTMRI data of a heart is integrated to form streamlines, the process is known as tractography and streamlines run along myofibers. Integration of the discrete vector field to form streamlines may be based on:

$${\int }_{0}^{t} dp = p ( t ) - p ( 0 ) = {\int }_{0}^{t} {e}_{1} ( p ( t ) ) d τ \qquad ( 5 )$$

where p represents the parametric streamline curve, e₁ is the major eigenvector of the diffusion tensor as a function of position, and p(0) is the seed point for the integration.

Numerical methods may perform the path integration. Examples of numeral methods include Runge-Kutta algorithms, moving least squares (MLS) tracing, Dormand-Prince methods, and Euler's method. A dense set of streamlines may be generated by repeatedly performing path integration along the primary diffusion direction field for an array of seed points distributed throughout the scan volume. In some examples, tractography of human cardiac tissue uses Euler Delta Crossings (EuDX), which is a simple deterministic tracking algorithm that uses Euler's method for path integration, provided by the open-source diffusion MRI Python package DIPY. EuDX uses trilinear interpolation of the major eigenvector e₁ at each voxel (where eᵢ is defined at the center of each voxel) to define a continuous fiber orientation field v(x). Starting from a seed point, p₀, the continuous integration may be iteratively carried out using Euler's method:

$${p}_{n + 1} = {p}_{n} + v ( {p}_{n} ) Δ s \qquad ( 6 )$$

where Δs is the propagation step size.
Discrete integration may be terminated once a streamline reaches a predefined maximum length lₘₐₓ, reaches the border of the region of interest defined by a segmented voxel mask M, or reaches a predefined maximum propagation deviation angle θₚᵣₒₚ, yielding a discrete sequence of points representing a contour in 3D space. In some examples, this integration is performed for an array of seed points distributed throughout the mask volume to yield a set of streamlines filling the region of interest. The system may generate seeds throughout the masked region of interest with a density of 2×2×2 seeds per voxel, using the utils_seeds_from_mask function in DIPY. From each starting seed, tractography may proceed with a step size of 0.5.

A slightly modified version of EuDX, which generates streamlines in both the forward and backward directions from each seed point, may generate the initial dense set of streamlines S. To begin, evenly spaced seed points may be generated throughout the interior of the binary voxel mask M, at a density of (n_{seed})³ seeds per voxel. For each seed point, the numerical integration may be performed along both the orientation field v and its antiparallel orientation field −v, yielding two distinct streamlines, one in the forward (p_{f}) and one in the backward (p_{b}) direction. The initial numerical tracking step is given by:

$$\begin{matrix}{p}_{1 , f} = {p}_{0} + v ( {p}_{0} ) Δ s & ( 7 ) \\ {p}_{1 , b} = {p}_{0} - v ( {p}_{0} ) Δ s & ( 8 )\end{matrix}$$

For propagation beyond the initial step, the orientation field v(pₙ) for both the forward and backward streamlines may be taken to be in the same sense as v(pₙ₋₁), the orientation field at the previous point for that streamline, to avoid sudden reversal of the tracking direction:

$${p}_{n + 1} = \{ \begin{matrix}{p}_{n} + v ( {p}_{n} ) Δ s & v ( {p}_{n} ) * v ( {p}_{n - 1} ) \geq 0 \\ {p}_{n} - v ( {p}_{n} ) Δ s & v ( {p}_{n} ) * v ( {p}_{n - 1} ) < 0\end{matrix} \qquad ( 9 )$$

Streamlines may be terminated after reaching a predefined maximum length lₘₐₓ or reaching the outer boundary of the voxel mask M. In some examples of streamline generation for a left ventricle of a heart, the maximum streamline length (max is set to half the circumference of the left ventricle, to avoid excessive toolpath length which may lead to unnecessary interference during 3D printing. In other examples, lₘₐₓ may be based on a circumference of an object which is being 3D printing such as being ½ the circumference, ⅓ the circumference, ¼ the circumference, or any other proportion based on the scanned object or the object being 3D printed.

A bidirectional tracking scheme effectively doubles the number of the streamlines generated compared to unidirectional tracking, which may result in a more comprehensive spatial coverage of the initial streamline set S, which may increase the number of potential toolpath sequences to be selected for the final sequence T. FIG. 5C is an example of a dense set of streamlines generated using bidirectional tracking.

Partitioning of the one or more generated streamlines (850) may be based on characteristics of the streamline relative to nearby streamlines or the geometry of the streamline. For example, when characterizing myocardial fiber architecture, myocardial helical angle (HA) may be used. Helical angle may be defined as the angle of inclination between a myofiber and a plane transverse to the left ventricle. Myofibers that wind upwards-clockwise (when viewed from above) have a negative helical angle and myofibers that wind upwards-counterclockwise have a positive helical angle. Various methods may assign an HA value to entire streamlines. In some examples, HA are assigned by taking the median, minimum, or maximum HA along the length of the streamline. In other examples, HA are assigned by taking the mean HA to characterize each streamline. The mean HA for a streamline C, taken to be a sequence of M points {pᵢ}₁^{M} is calculated by averaging the helical angle of each segment of the discrete contour:

$${HA}_{mean} ( C ) = \frac{1}{M - 1} {\sum }_{i = 1}^{M - 1} HA ( {pP}_{i + 1} - {p}_{i} ) \qquad ( 10 )$$

Myocardial helical angle transitions from the endocardium (interior surface) to the epicardium (exterior surface) of the left ventricle in a roughly linear fashion for healthy human hearts. If the HA transition across the ventricle wall is linear, the HA of a streamline is directly proportional to its lateral position along the ventricle wall. Partitioning S into a sequence of N subsets with identical HA ranges, the partitioned subset sequence {Sᵢ}₁^{N} represents concentric groups of streamlines with roughly equal thicknesses. In some examples, a print may be inverted during printing and concentric partitions may be printed sequentially from the innermost partition S₁ to the outermost partition S_{N}, where each partitioned subset Sᵢ may act as a “pseudolayer”. In the example of printing a left ventricle of a heart, an inversion during printing orients an apex to the top with the innermost partitions being endocardial tissue and the outermost partitions being epicardial tissue. In other examples, the inversion and directionality of partitioning may be based on the printability of the specific geometry of the printed object. Partitioned “pseudolayers” may be printed consecutively (i.e., starting with the innermost shell and working outwards) with minimal interference. In some examples, partitioning streamlines under the linear transmural HA transition assumption does not yield uniformly thick pseudolayers for the data set used. The resulting partitions in {Sᵢ}₁^{N} may largely retain their concentric nature, such that sequential pseudolayer printing still serves the function of minimizing interference during printing.

Streamlines may be thinned to a subset of the streamlines (855). Thinning may include iterative thinning, random subset selections, iterative random thinning, or sweep exclusion. Iterative thinning, random subset selections, and iterative random thinning are discussed above with respect to FIG. 8A. With sweep exclusion, each partition Sᵢ may be reduced to a representative subset (Sᵢ)_{thinned} by selecting a subset of streamlines to be used directly as toolpaths. Sweep exclusion may select a subset (Sᵢ)_{thinned}⊆Sᵢ of noninterfering streamlines that are parallel and uniformly distributed in space. Sweep exclusion may produce a toolpath set for each partition yielding spatially uniform material deposition and maximum volumetric coverage.

Sweep exclusion may iteratively select a streamline of interest C_{swept}∈Sᵢ, creating a bounding cylinder by “sweeping” a circular cross-section along C_{swept}, and removing from Sᵢ any streamlines C∈Sᵢ−{C_{swept}} containing any portion in the swept cylinder as illustrated by FIG. 9C. A diameter of the swept cylinder may be set to 2wωₛ−ϵ for a suitable line spacing of wωₛ. Some small positive value ϵ_{may} be included in the diameter of the swept cylinder such that any streamlines exactly wωₛ away from C_{swept} are not within the boundary of the swept cylinder, and therefore are not removed. The remaining streamline nearest to C_{swept} is selected for sweeping, and the process of creating bounding cylinders and removing intersecting streamlines may be repeated until all remaining streamlines have been swept. The final remaining toolpath set is (Sᵢ)_{thinned}. An outline of the sweep exclusion algorithm is given in Algorithm: Sweep exclusion.

The following algorithm is an example of Sweep exclusion.
Data: streamline set A, ideal inter-streamline spacing wωₛ, small positive value E
Result: A is reduced to a representative subset A_{thinned}

```
begin
  A_{swept} ← −Ø
  while A − A_{swept} ≠ 0 do
    if A swept = Ø then // choose first path
      C_{swept} ← −LongestPath(A)
    else
      C_{swept,next}←− arbitrary streamline in A
      for each streamline Cᵢ ∈ A − A_{swept} do
        if MDF(Cᵢ, C_{swept}) < MDF(C_{swept,next}, C_{swept}) then
          C_{swept,next}← Cᵢ
      C_{swept}← C_{swept,next}
    A_{swept} ← A_{swept} ∪ {C_{swept}}
    cylinder ← CreateSweptCylinder(C_{swept}, 2ωₛ − ∈)
    for each streamline Cᵢ ∈ A − A_{swept} do
      if Intersects(Cᵢ, cylinder) then
        A = A − {Cᵢ}
```

In some examples, streamline smoothing may be applied to Sᵢ and/or (Sᵢ)_{thinned}. In some examples, vector field smoothing may be applied to eᵢ(x) before tractography. In some examples, streamline or vector field smoothing may be applied to the interior surface of the endocardium, or perhaps throughout the left ventricle altogether, to improve local parallelity. Vector field and/or streamline smoothing may yield more parallel and equally spaced toolpaths which may improve the efficiency and/or spatially uniform coverage of the sweep exclusion process.

Inter-streamline distance may be a perpendicular distance between a given pair of streamlines. Selecting the next swept path includes calculating the distance between C_{swept} and all other streamlines C∈1−{C_{swept}} and selecting the streamline with the smallest distance. Inter-streamline distance for nonparallel streamlines in 3D space (i.e., streamlines in each Sᵢ which are not uniformly distributed and exactly parallel) may be approximated with minimum average direct-flip (MDF) distance. MDF distance may be an inter-streamline metric which may guide sequential path selection during sweep exclusion.

The MDF distance between two streamlines C₁ and C₂, each represented by a sequence of M points {p_{1,i}}₁^{M} and {p_{2,i}}₁^{M}, respectively, may be the minimum of d_{direct}(C₁, C₂) and d_{flipped}(C₁, C₂), the mean Euclidean distance between pairs of points in each sequence, paired in the forward and backward directions.

$$\begin{matrix}{d}_{direct} ( {C}_{1} , {C}_{2} ) = d ( {C}_{1} , {C}_{2} ) = \frac{1}{M} {\sum }_{i = 1}^{M} ‖ {p}_{1 , i} - {p}_{2 , i} ‖ & ( 11 ) \\ {d}_{flipped} ( {C}_{1} , {C}_{2} ) = d ( {C}_{1} , {C}_{2}^{F} ) = ( {C}_{1}^{F} , {C}_{2} ) & ( 12 ) \\ MDF ( {C}_{1} , {C}_{2} ) = min ( {d}_{direct} ( {C}_{1} , {C}_{2} ) , {d}_{flipped} ( {C}_{1} , {C}_{2} ) ) & ( 13 )\end{matrix}$$

In some examples, both streamlines may contain the same number of points M to perform the MDF calculation. In some examples, if two streamlines contain a different number of points, the streamline with more points is subsampled such that both streamlines contain the same number of points. MDF distance may be minimized by streamlines that are generally nearby, parallel, and of similar length. MDF-based next path selection may retain the density of a streamline set during sweep exclusion as subsequent C_{swept} selections may be parallel to and near the boundary of the swept cylinder created around the previous C_{swept}.

C_{swept} may be set to the longest streamline in the input set to begin sweeping. Similar length streamlines may minimize MDF distance. In some examples, the sweeping process is initialized with the longest streamline. Initializing with the longest streamline may favor subsequent selection of longer streamlines which may increase the average toolpath length of the final thinned set. Increased average toolpath length may exhibit more uniform material deposition and promote contiguous muscle fiber formation.

In the example of printing a left ventricle, the thinned streamline partitions near the epicardium (outer shells) may be highly parallel and evenly spaced, with parallelness and uniform spacing decreasing for partitions nearer the endocardium (inner shells). In some examples, trabeculations may cause lower tract coherence as a result of increasing turbulence of the fiber orientation field near the endocardium.

A segment-wise procedure may determine if a given streamline Cᵢₙₜ, defined by a sequence of M points {qⱼ}₁^{M}, intersects the bounding cylinder of a streamline C_{swept} defined by a sequence of N points {qⱼ}₁^{M}. Consider the segments P=p̅ᵢ̅+̅p̅ᵢ̅₊̅₁̅ and Q=q̅ᵢ̅+̅q̅ᵢ̅₊̅₁̅. First, two planes nᵢ and nᵢ₊₁ are defined by the bisection of pᵢ and pᵢ₋₁, and pᵢ₊₁ and pᵢ₊₂, respectively. These planes define the “endcaps” of the bounding cylinder for segment P. The segment Q is truncated to be within these planes, yielding Q_{T}. If Q is completely outside nᵢ and nᵢ₊₁, intersection between the segment Q∈Cᵢₙₜ and the bounding cylinder created around P∈C_{swept} is not possible. If Q does contain a portion within nᵢ and nᵢ₊₁, P and Q_{T} are expressed parametrically as:

$$\begin{matrix}p ( t ) = {p}_{i} + ( {p}_{i + 1} - {p}_{i} ) t & ( 14 ) \\ {q}_{T} ( s ) = {q}_{T , 1} + ( {q}_{T , 2} - {Q}_{T , 1} ) s & ( 15 )\end{matrix}$$

respectively.

A distance function D(s, t) defines the square of the Euclidean distance between the two segments:

$$D ( s , t ) = {‖ p ( t ) - {q}_{T} ( s ) ‖}^{2} \qquad ( 16 )$$

The square root of the minimum value of D in the region s∈[0, 1], t∈[−∞, ∞] represents the minimum distance dₘᵢₙ between the infinite line containing P and the line segment Q_{T}. The infinite line containing P, defined by p(t) for t∈[−∞, ∞], is taken because nᵢ and nᵢ₊₁ are not necessarily parallel. Therefore, it is possible for an endpoint of Q_{T} to yield a minimum distance to P, beyond the segment defined by p̅ᵢ̅+̅p̅ᵢ̅₊̅₁̅. If dₘᵢₙ is less than the radius rₛ of the bounding cylinder, the streamline Cᵢₙₜ intersects the bounding cylinder of C_{swept}.

Next, a processing circuitry may remove cyclicality between the one or more streamlines based on the dependencies Gᵢ (865). To directly use the streamlines in each (Sᵢ)_{thinned} as toolpaths, each (Sᵢ)_{thinned} may be ordered into a toolpath sequence Tᵢ. Toolpath sequence Tᵢ. may order each streamline Sᵢ such that during sequential material deposition along each toolpath in Tᵢ, the 3D printer extruder does not obstruct material deposited along previously printed toolpaths. A predictive model may define relative ordering restrictions between each pair of streamlines [symbol] Cⱼ, Cₖ [symbol] in (Sᵢ)_{thinned}.

Dependency graph G contains vertices representing toolpaths and directed edges [symbol] Cⱼ, Cₖ [symbol] indicating that toolpath Cₖ must precede C; in the toolpath ordering. A geometric model for the 3D printer's extruder and the deposited print lines enables creation of the dependency graph.

For each thinned partition (Sᵢ)_{thinned}, a dependency graph Gᵢ may be created containing |(Sᵢ)_{thinned}| vertices. Each vertex may correspond to a toolpath in (Sᵢ)_{thinned}, such that V(Gᵢ)=(Sᵢ)_{thinned}. Gᵢ may contain the directed edge [symbol] Cⱼ, Cₖ [symbol] if Cₖ precedes Cⱼ in the toolpath ordering (Cⱼ “depends on” Cₖ). A toolpath C; depends on Cₖ if, during the extrusion of Cₖ, the extruder would interfere with the deposited material along Cⱼ. To determine whether a toolpath Cⱼ depends on Cₖ, bounding volumes E and M are created for the extruder throughout the deposition of Cₖ and the deposited material along Cⱼ, respectively. If E and M intersect (i.e., E∩M≠Ø), then interference may occur, so [symbol] Cⱼ, Cₖ [symbol] ∈Gᵢ.

In some examples, a 3D bioprinter may be used. Bioprinters may include a stainless steel-tipped syringe nozzles. A simple vertical cylinder of diameter dₙ, where dₙ is the outer diameter of the nozzle, may be sufficient to characterize the bounding geometry of the nozzle tip. The deposited material volume is taken to have a square cross-section with side length dₚ. In some examples, and depending on the specific printing methodology, setup, and printing/support materials used, the cross-section of deposited material may be circular. In other examples, the cross-section of deposited material may be square. In yet other examples, the cross-section of deposited material may be an oval, a rounded square, a rectangle, or any other suitable shape to approximate a cross-section of the deposited material. To ensure material interference is avoided, M is defined by a square cross-section with side lengths equal to the expected print diameter dₚ.

To determine if a given E and M intersect, the bottom surface of E and the top surface of M may be considered e(x, y): [symbol] ²→ [symbol] and m(x, y): [symbol] ²→ [symbol] . E and M intersect if there exists a point (x, y) in the domain of both m and e such that e(x, y)<m (x, y) (i.e., the bottom surface of E lies below the top surface of M).

For every pair of streamlines [symbol] Cⱼ, Cₖ [symbol] for j, k ∈[1, |(Sᵢ)_{thinned}, |] j≠k, where Cⱼ, Cₖ ∈(Sᵢ)_{thinned}, the surfaces eₖ and mⱼ are constructed. If eₖ(x, y)<mⱼ(x, y) for any point (x, y) in the domain of both eₖ and mⱼ, the directed edge [symbol] Cⱼ, Cₖ [symbol] is added to Gᵢ, indicating that Cₖ must precede Cⱼ in the toolpath ordering.

If (Sᵢ)_{thinned} is cyclical, (i.e., one streamline depends on another streamline), (Sᵢ)_{thinned} may be unable to yield an ordering Tᵢ that is printable without material interference and therefore if the corresponding dependency graph Gᵢ is acyclic, (Sᵢ)_{thinned} may be able to yield an ordering Tᵢ. In graph theory, a cycle is a path that starts and ends at the same vertex, traversing through a sequence of directed edges. If Gᵢ contains any cycles, for any ordering Tᵢ of V(Gᵢ), there exists a toolpath Cⱼ∈Tᵢ such that [symbol] Cⱼ, Cₖ [symbol] ∈Gᵢ for some Cₖ∈Tᵢ, k∈[j+1, |Tᵢ|]. In other words, if a cycle exists in Gᵢ, no V(Gᵢ) exists such that all toolpaths depend only on preceding toolpaths in the sequence. In other examples, parameters of V(Gᵢ), such as the print capabilities of a printer or the capabilities of a print bed or print medium, may obviate toolpath ordering concerns.

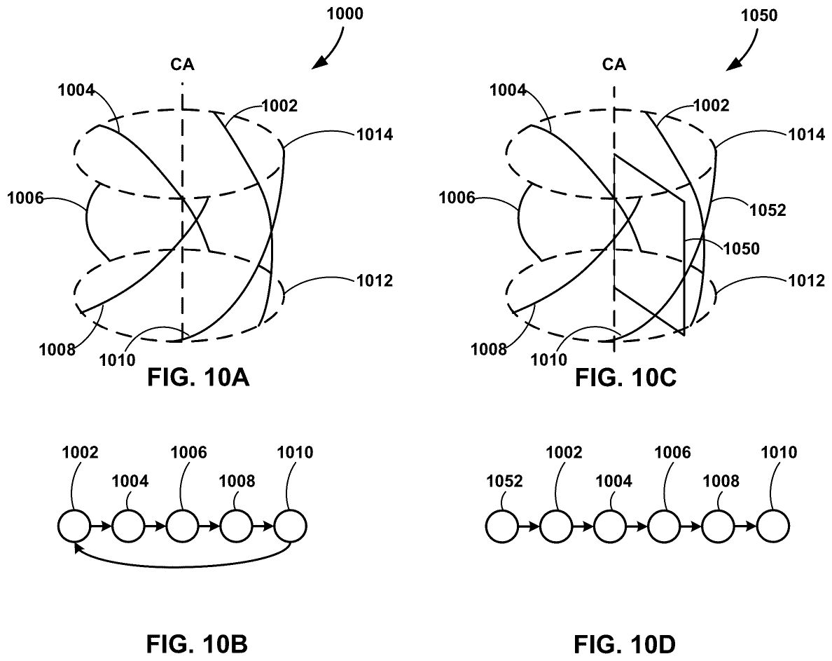

If Gᵢ is acyclic, then V(Gᵢ) is orderable. Two sequential methods may be applied to ensure Gᵢ is acyclic. A “cut plane,” such as described below in FIG. 10C-10D may be configured to split streamlines along a vertical plane, removing a large number of inherent cycles arising from helical streamlines. In the example of a left ventricle, myofiber structure is naturally cyclical.

Additionally or alternatively, other cycles may be removed procedurally using a heuristic-based method that iteratively removes vertices from Gᵢ determined to be likely contained in a cycle. A heuristic dubbed “iterative maximum cycle potential removal” may select a maximum acyclic vertex subset V((Gᵢ) acyclic) ⊂V (Gᵢ) such that V(Gᵢ)-V((Gᵢ) acyclic) is the minimum feedback vertex set of Gᵢ.

Iterative maximum cycle potential removal is a vertex removal method, as opposed to an edge removal method. In the context of the dependency graph, edge removal is equivalent to breaking the dependency between two toolpaths, geometrically modifying the toolpath geometry. Vertex removal may eliminate entire toolpaths. Iterative maximum cycle potential removal is highly efficient, removing only a small percentage of toolpaths. If Gᵢ is cyclic, the “cycle potential” (CP) is calculated for each vertex in Gᵢ, and the vertex v with the highest CP is removed from Gᵢ (with any edges containing v as a terminal or initial vertex subsequently removed). CP is defined as the product of the in-degree and out-degree of a vertex v wherein CP(v)=deg⁻(v)*deg⁺(v). CP(v) describes the number of potential routes a cycle could take through v. A vertex with a higher CP may be more likely to be contained in a cycle. This process may be repeated until Gᵢ is acyclic. An overview of iterative maximum cycle potential removal is given in Algorithm: Iterative maximum cycle potential removal.

The following algorithm is an example of iterative maximum cycle potential removal

Data: dependency graph Gᵢ
Result: Gᵢ is reduced to an acyclic subgraph (Gᵢ) acyclic

```
begin
  while Gᵢ is cyclic do
    νₘₐₓ ← arbitrary vertex in V (Gᵢ)
    for each vertex v ∈ V (Gᵢ) do
      if CP(v) > CP(νₘₐₓ) then
        νₘₐₓ ← v
    Gᵢ ← Gᵢ/{νₘₐₓ}
```

Processing circuitry may be configured to order the one or more streamlines into toolpaths (870). A greedy search algorithm may order the toolpaths in each V(Gᵢ) acyclic into a sequence Tᵢ={Cⱼ}ⱼ₌₁^{|V((G}^{ᵢ}⁾^{_{acyclic}}^{|} that is “printable”. A sequence Tᵢ is defined as printable if for every toolpath Cⱼ∈Tᵢ, Cⱼ does not depend on any subsequent toolpaths Cₖ for k∈[j+1, | V(Gᵢ) acyclic], i.e., [symbol] Cⱼ, Cₖ [symbol] ∉(Gᵢ) acyclic.

Take Uᵢ=V(Gᵢ) acyclic, such that Uᵢ is the unordered set of toolpaths for a partition i. Greedy search may attempt to populate Tᵢ (initially empty) by sequentially appending toolpaths from Uᵢ such that the total travel cost between toolpaths in Tᵢ is minimized. The travel cost between two sequential toolpaths Cⱼ and Cⱼ₊₁ is defined as the Euclidean distance between p_{|c}_{ⱼ}_{|,j} the last point of Cⱼ, and p_{1,j+1}, the first point of Cⱼ₊₁:

$$Tr ( {C}_{j} , {C}_{j + 1} ) = ‖ {p}_{\vert {C}_{j} \vert {C}_{j} , j} - {p}_{1 , j + 1} ‖ \qquad ( 17 )$$

The goal of the greedy search is to yield a toolpath sequence Tᵢ that minimizes the total travel cost function:

$$J ( {T}_{i} ) = {\sum }_{j = 1}^{\vert {T}_{i} - 1 \vert} Tr ( {C}_{j} , {C}_{j + 1} ) \qquad ( 18 )$$

For any unordered toolpath set Uᵢ, the sum of the toolpath lengths in Uᵢ is constant and is not altered by their ordering in Tᵢ. The only distances that may be altered by ordering Uᵢ into Tᵢ are the inter-toolpath travels. A toolpath ordering Tᵢ that minimizes J (Tᵢ) may decrease total print time.

The greedy search operates by traversing nodes in the search tree according to a heuristic function H(n). Each node n in the search tree is defined by a local ordered toolpath sequence n·Tᵢ, where the root node has |n·Tᵢ|=0, the children of the root node (each lying at depth 1 in the search tree) have |n·Tᵢ|=1, and so on, such that every depth-increasing node traversal represents appending to n·Tᵢ a toolpath from the set of remaining unordered toolpaths Uᵢ−{Cⱼ∈n·Tᵢ|j∈[1, |n·Tᵢ|]}. The heuristic function H(n) provides an estimate of how “close” a given node is to a solution node, where a solution node may be defined by a completely ordered toolpath sequence with |n·Tᵢ|=|Uᵢ|. Nodes with a lower heuristic cost have absolute traversal priority (a characteristic of standard greedy search). Upon expansion of a parent node, one of the resulting children nodes may be traversed. Within a set of children nodes, the child n with the lowest total inter-toolpath travel cost between toolpaths in n·Tᵢ may be traversed first. The heuristic function for a node n is defined by:

$$H ( n ) = ( \vert {U}_{i} \vert - \vert n \cdot {T}_{i} \vert ) {L}_{max} + {\sum }_{j = 1}^{\vert n \cdot {T}_{i} \vert - 1} Tr ( n \cdot {C}_{j} , n \cdot {C}_{j + 1} ) \qquad ( 19 )$$

where Lₘₐₓ is the largest possible travel cost between a pair of toolpaths in Uᵢ.

Lₘₐₓ may be taken to be the diagonal length of the axis-oriented bounding box containing all toolpaths in Uᵢ. n·Cⱼ denotes the jth term in the sequence n·Tᵢ. H(n) may be minimized by nodes with a larger ordered toolpath sequence (i.e., greater |n·Tᵢ|). Nodes with a larger ordered toolpath sequence may be “closer” to a completely ordered solution state. H(n) may decrease along a continuous traversal route from the root node to a solution node. (i.e., for a given traversal route, nodes deeper in the search tree-equivalently possessing a larger ordered toolpath sequence-necessarily have a lower heuristic cost). For example, consider two nodes in the search tree u and v such that v represents a child node of u. The sequences u·Tᵢ and v·Tᵢ are identical, with the exception that v·Tᵢ contains an additional toolpath, such that |v·Tᵢ|=|u·Tᵢ|+1 and the sequence u·Tᵢ is equivalent to the first |u·Tᵢ| terms of the sequence v·Tᵢ, defined by {v·Cⱼ}ⱼ₌₁^{|u·T}ᵢ|. The heuristic function for the child node v is given by:

$$H ( v ) = ( \vert {U}_{i} \vert - \vert v \cdot {T}_{i} \vert ) {L}_{max} + {\sum }_{j = 1}^{\vert v \cdot {T}_{i} \vert - 1} Tr ( v \cdot {C}_{j} , v \cdot {C}_{j + 1} ) \qquad ( 20 )$$

where substituting |v·Tᵢ|=|u·Tᵢ|+1 yields:

$$H ( v ) = ( \vert {U}_{i} \vert - \vert u \cdot {T}_{i} \vert ) {L}_{max} - {L}_{max} + {\sum }_{j = 1}^{\vert u \cdot {T}_{i} \vert - 1} Tr ( v \cdot {C}_{j} , v \cdot {C}_{j + 1} ) \qquad ( 21 )$$

and using the equivalency of the first |u·Tᵢ| terms of u·Tᵢ and v·Tᵢ yields:

$$H ( v ) = ( \vert {U}_{i} \vert - \vert u \cdot {T}_{i} \vert ) {L}_{max} - {L}_{max} + {\sum }_{j = 1}^{\vert u \cdot {T}_{i} \vert - 1} [ Tr ( u \cdot {C}_{j} , u \cdot {C}_{j + 1} ) ] + Tr ( {C}_{\vert v \cdot {T}_{i} \vert - 1} , {V}_{\vert v \cdot {T}_{i} \vert} ) \qquad ( 22 )$$

using the definition of the heuristic function H yields:

$$H ( v ) = H ( u ) - {L}_{max} + Tr ( {C}_{\vert v \cdot {T}_{i} \vert - 1} , {V}_{\vert v \cdot {T}_{i} \vert} ) \qquad ( 23 )$$

By definition, Lₘₐₓ is larger than the travel distance between every pair of toolpaths in Tᵢ and Lₘₐₓ>Tr(C_{|v·T}_{ᵢ}_{|-1}, C_{|v·T}_{ᵢ}_{|}). Therefore H(v)<H(u), regardless of the toolpath geometry of v·Tᵢ and u·Tᵢ. Each child node in the search tree may therefore have a lower heuristic cost than its parent node.

The term Σⱼ₌₁^{|n·T}^{ᵢ}^{|-1} Tr(n·Cⱼ, n·Cⱼ₊₁) may compute the travel distance sum between each toolpath in n·Tᵢ. Therefore, within a set of children nodes descending from a common parent node, the child with the smallest total travel distance between sequential toolpaths in Tᵢ may have the smallest heuristic cost. This characteristic of the heuristic function guides the search procedure along nodes containing shorter average inter-toolpath travels, such that the found solution node nₛₒₗᵤₜᵢₒₙ yields a smaller total travel cost J(nₛₒₗᵤₜᵢₒₙ·Tᵢ).

The expansion of children nodes from each parent node is restricted to the set of children nodes that append to Tᵢ a toolpath C∈Uᵢ that is not dependent on any other remaining unordered paths in Uᵢ−{Cⱼ∈n·Tᵢ|j∈[1, |n·Tᵢ|]}. This ensures that for any solution node nₛₒₗᵤₜᵢₒₙ, for any streamline Cⱼ∈nₛₒₗᵤₜᵢₒₙₛ. Tᵢ, Cⱼ does not depend on any subsequent toolpaths Cₖ for k∈[j+1, |s·Tᵢ|], and any found solution node nₛₒₗᵤₜᵢₒₙ yields an ordered toolpath sequence nₛₒₗᵤₜᵢₒₙ·Tᵢ that may be printable.

The following algorithm is an example of a Greedy search
Input: unordered toolpath set U, dependency graph G.
Output: ordered toolpath sequence Tᵢ or failure if G is not acyclic.

| begin | |
|---|---|
| queue ← PriorityQueue( ) | // ordered by H |
| queue.add(node n with empty toolpath sequence n.T ) | |
| while queue not empty do | |
| n ← queue.pop( ) | |
| if \|n.T\| = \|U\| then | // current node is solution |
| return n.T | |
| U_{unordered} ← U − {Cᵢ ∈ n.T\|i ∈ [1, \|n.T\|]} | // remaining |
| toolpaths | |
| for Ci ∈ U_{unordered} do | |
| for Cⱼ ∈ U_{unordered} − {Cᵢ} do | |
| if [symbol] Cᵢ, Cⱼ [symbol] ∈ G then | // n.T [symbol] {Cᵢ} is unprintable |

```
          go to next Cᵢ
        v ← node with v.T = n.T [symbol]   {Cᵢ}
        queue.add(v)
  return failure // G is not acyclic, no orderable solution
```

Processing circuitry may be configured to post process the one or more toolpaths (875). The ordered toolpath sequences Tᵢ for each partition may be sequentially ordered and concatenated into a holistic toolpath sequence T=\hat{T}₁\hat{T}₂ . . . . T_{N}. In an example of bioprinting a left ventricle of a heart, tissue is ordered from endocardium to epicardium based on sequential ordering and therefore pseudo layers are printed sequentially, starting with the innermost shell. Reducing T to a sequence of toolpaths may include removing any streamlines in T resulting in direct material interference between partitions. Regions near the boundary of bordering partitions may contain interfering toolpaths because each partition Sᵢ is thinned and ordered independently as described throughout above.

Any direct interference may be removed by sweep exclusion on the holistic toolpath sequence T with a suitable line spacing wωₛ=dₚ (diameter of printed lines) such that the swept cylinders created during sweep exclusion effectively simulate the material deposition process, and any direct material interference is removed. Sweep exclusion may be implemented in a similar manner to sweep exclusion as described with reference to 855 above and/or to FIG. 9C below.

Processing circuitry may be configured to generate G-code based on the post-processed toolpath (875). The final toolpath sequence is translated to G-code. A 3D printer may be configured to print the G-code (880). In some examples, the G-Code is sent to a 3D bioprinter to fabricate a fiber-oriented model of the isolated left ventricle. In other examples, the G-code is sent to a 3D silicone printer. The silicone printer may print an acellular, model was fabricated using a gelatin microparticle support bath.

FIG. 9A is a conceptual diagram 900 of different streamlines for a toolpath. FIG. 9B is a conceptual diagram 920 illustrating distances between the streamlines of FIG. 9A. FIG. 9C is a conceptual diagram 940 illustrating the process of sweep exclusion. FIGS. 9A-9C are discussed together for clarity.

FIGS. 9A and 9B are perpendicular planes at “i-th” point 908 of the streamline of interested streamline 902. “i-th” point 908 may be a point selected along streamline 902 at a distance between first end 904 of streamline 902 and second end 906 of streamline 902. “i-th” point 908 may be based on an integer “i” which may be selected randomly, iteratively, or heuristically. The integer “i” may represent a segment of streamline 902 as streamline 902 may be digitally divided into segments and integer “i” may represent the “i-th” segment from first end 904 of streamline 902. As shown in FIG. 9B, with regard to N-directional spacing visualization, N=3 and therefore there are three angular sections 922, 926, and 930 divided by radial segment lines 924, 928, and 932. FIG. 9B illustrates the distance from each selected streamline of the subset of streamlines to streamline 902.

Four example methods may be used for streamline subset selection: iterative thinning, random subset selection, iterative random thinning, and sweep exclusion. The subset selection is discussed above with regard to 810-825 of FIG. 8. Iterative thinning 810, random subset selection 815, and iterative random thinning 820 rely on some metric for determining the “spacing” of a given streamline. One potential method for determining streamline spacing is “N-directional average spacing,” which make be referred to as “spatial partitioning” or “binning” which divides a selected region into smaller partitions and analyzes each of the partitions. For each point on a given streamline, the spacing value for that point is the average of the distance to the nearest neighboring streamlines in N angular directions. As shown in FIG. 9B, N=3 and therefore three angular sections 922, 926, and 930 are used. These angular directions may be defined by segmenting the “i-th” plane that is perpendicular to the streamline at the point of interest into these N angular sections, that emanate from “i-th” point 908. Three radial segment lines 924, 928, and 932 may bound the three angular sections 922, 926, and 930, wherein three radial segment lines 924, 928, and 932 extend from “i-th” point 908 in the “i-th” plane. Three radial segment lines 924, 928, and 932 may be equally circumferentially spaced such that there is 120 degrees of separation between radial segment lines 924, 928, and 932. In some examples, radial segment lines may be unevenly spaced such that one or more of radial segment lines 924, 928, and 932 are closer to one or more of the other radial segment lines 924, 928, and 932. In other examples, N=2, 4, 5, or any other number such that there are any suitable number of angular directions and therefore any suitable number of radial segments.

Conceptual diagram 940 illustrates a potential implementation of sweep exclusion 825. Bounding cylinder 942 may be formed at radius 944 from streamline 902 between first end 904 of streamline 902 and second end 906 of streamline 902. Streamlines 946a and 946b may intersect with bounding cylinder 942 where streamlines 948a and 948b may not intersect with bounding cylinder 942. Intersections of streamlines 946a and 946b with bounding cylinder 942 may be calculated and all intersecting streamlines may be removed.

This may be repeated until, for each streamline, no other streamlines intersect its bounding cylinder 942. Setting radius 944 of this cylinder to a suitable spacing ensures that for any two given streamlines, the distance between any two points on them will never be less than the suitable spacing. The cylinder diameter, or radius 944, may be determined based on the 3D printing nozzle size, cell size, or any other printing constraint or parameter. Many variations may be made on the sweep exclusion process, such as: only excluding streamlines if a certain percentage of the streamline lies within another streamline's bounding cylinder; using a non-random method for selecting the order in which streamlines are swept, potentially based on inter-streamline distance metrics or the spatial position of streamlines; and/or “partitioning” streamlines into certain helical angle ranges and adding the removal criteria that a streamline may be within the same helical angle range as the streamline being swept. In some examples, “partitioning” may be referred to as “binning.” These algorithms are outlined in Algorithms 2a, 2b, 2c, and 2d respectively.

The following algorithm is an example of Iterative Thinning.
Data: streamline set S, desired spacing d
Result: thinned streamline set S′

```
while AverageSpacing(S)< d do
  s ← DensestStreamline(S)
  S.remove(s)
end
```

The following algorithm is an example of Random Subset Selection.
Data: streamline set S, desired spacing d, tolerance t, subset size N
Result: thinned streamline set S′

Sₜₑₘₚ ← RandomSubset(S, N)
while AverageSpacing(Sₜₑₘₚ) ∉ (d − t, d + t) do
Sₜₑₘₚ ← RandomSubset(S, N)
end
S ← Sₜₑₘₚ

The following algorithm is an example of Iterative Random Thinning.
Data: streamline set S, desired spacing d
Result: thinned streamline set S′

```
while AverageSpacing(S)< d do
  s ← SelectRandomStreamline (S)
  S.remove(s)
end
```

The following algorithm is an example of Sweep Exclusion.
Data: streamline set S, sweep diameter d
Result: thinned streamline set S′

```
S_{visited} ← Ø
while S [symbol]   S_{visited} do
  S_{unvisited} ← S − S_{visited}
  C_{swept} ← minDistance(S_{unvisited}, C_{swept,previous})
  add the streamline C_{swept} to the set S_{visited}
  foreach C in S_{unvisited} do
    if C is C_{swept} do
      continue to the next streamline
    else if C intersects swept circle of diameter d along C_{swept} then
      remove C from S
  end
end
```

After selecting a subset of streamlines to use as toolpaths, the toolpaths may be ordered for printing, for example toolpath ordering 830 of FIG. 8. A greedy search algorithm may be a toolpath ordering process, where at each step in the greedy search algorithm, the search space is constrained to toolpaths that are printable. From a given toolpath, the next toolpath will be selected by finding the nearest unprinted toolpath that is printable. When selecting the next toolpath, toolpaths are considered for traversal in either direction. This process will be repeated until a printable sequence of toolpaths is found. If a printable sequence of toolpaths is exists, the greedy search algorithm will find it. The greedy search algorithm may not find the solution with the smallest total travel distance and therefore may not be the most time efficient solution. For example, because the search space of potential toolpath sequences is so large (e.g., proportional to 2ⁿn!, where n is the number of toolpaths), optimal search algorithms may be more computationally intensive and may not be needed to establish a sufficient toolpath order. When determining the printability of a given toolpath, the 3D geometry of the printed toolpaths (i.e., the line height and line width of the deposited material) and the geometry of the extruder may be considered to avoid interference. As a result, the ordering search algorithm takes a set of 3D streamlines to use as toolpaths, the line height and width of deposited print lines, and the 3D geometry of the extruder as input. The output of the algorithm is an ordered sequence of toolpaths, where the printing direction of each toolpath is defined. In other examples, a locally optimal search may be performed to order the toolpaths.

The following algorithm is an example of Toolpath Ordering Algorithm with Greedy Search.

| | |
|---|---|
| input : | Toolpath Set S, |
| | Extruder Bounding Geometry G |
| | Print Line Width l_{w} |
| | Print Line Height lₕ |

output: Ordered Toolpath Sequence T
T ← GreedySearch(S, G, l_{w}, lₕ)

There are many variations of the algorithms outlined here that may convert streamline sets to G-code. This could include: using other metrics for streamline spacing; utilizing streamline spacing distributions rather than individual distances; artificial smoothing of streamlines, either before or after streamline subset selection; manually specifying the starting toolpath, instead of using random selection; averaging local distributions of streamlines to generate toolpaths; grouping streamlines into predefined non-planar layers to generate toolpaths; predefining the direction of printing to reduce the search space size; using uninformed search algorithms, such as depth-first search; using non-optimal search algorithms other than greedy search, such as random walk or simulated annealing; using optimal search algorithms, such as A* search, if computationally feasible; using random sampling search algorithms, such as Monte Carlo tree search; and/or training and using a machine learning model to guide tool path selection and ordering.

FIG. 10A is a diagram illustrating example toolpaths which are cyclically dependent and FIG. 10B is a state diagram illustrating the example toolpaths of FIG. 10A. FIG. 10C is a diagram illustrating the example toolpaths of FIG. 10A where a seam has been added to create acyclical dependency and FIG. 10D is a state diagram illustrating the example toolpaths of FIG. 10C.

The fiber orientation field of a left ventricle of a heart of a patient is generally helical and therefore is generally cyclic. For a set of helically arranged toolpaths, and therefore cyclic toolpaths, each toolpath is dependent on the toolpath(s) generally underneath it with respect to the print orientation. Helical toolpaths with even a small tilt angle exhibit inherent cycles. By splitting the streamlines in each (Sᵢ)_{thinned} along cut plane 1050 of FIG. 10C, any cycles in Gᵢ arising from the inherent helical structure of the toolpaths in V(Gᵢ) may be removed.

Cut plane 1050 may be a precursor to the creation of Gᵢ. Streamlines in each (Sᵢ)_{thinned} are first split along cut plane 1050, and the resulting streamlines may populate Gᵢ. The thickness, shape, direction, and orientation of cut plane 1050 is a function of an outer diameter of a print nozzle and the deposited material line width. To ensure that dependencies do not exist between streamlines across cut plane 1050, cut plane 1050 may be sufficiently thick to remove intersects between streamlines across the cut plane; however, a thicker cut plane removes more toolpath length.

FIG. 10A illustrates five example toolpaths (1002-1010) which are helically arranged and proceed from first plane 1012 to second plane 1014 and are centered around central axis CA. First plane 1012 and second plane 1014 may be arbitrary planes in space along central axis CA. Example toolpath 1002 proceeds counterclockwise around center axis CA from first plane 1012 to second plane 1014. Example toolpath 1004 is 72 degrees, or 2π/5 radians, counterclockwise of toolpath 1002 and proceeds counterclockwise around center axis CA from first plane 1012 to second plane 1014. Example toolpaths 1006, 1008, and 1010 are each respectively 72 degrees, or 2π/5 radians, counterclockwise of toolpaths 1004, 1006, and 1008 and proceed counterclockwise around center axis CA from first plane 1012 to second plane 1014. A first portion of toolpath 1002 near first plane 1012 may be supported by first plane 1012 whereas a second portion of toolpath 1002 near second plane 1014 may need the support of a portion of toolpath 1004. Likewise, first portions of toolpaths 1004, 1006, 1008, and 1010 near first plane 1012 may be supported by first plane 1012 whereas a second portions of toolpaths 1004, 1006, 1008, and 1010 near second plane 1014 may need the support of the first portions of toolpaths 1006, 1008, 1010, and 1002, respectively.

The dependencies of a second portion of toolpaths 1002, 1004, 1006, 1008, and 1010 near second plane 1014 may be seen in state diagram FIG. 10B. Specifically, the second portion of each toolpath near second plane 1014 depends on a first portion of a prior toolpath creating cyclicality. Toolpaths 1002, 1004, 1006, 1008, and 1010 may need the support of toolpaths 1004, 1006, 1008, 1010, and 1002 respectively.

FIG. 10C illustrates the addition of cut plane 1050 which divides toolpath 1010 into toolpaths 1010 and toolpath 1052. Cut plane 1050 may be a digital cut plane, where a processor is configured to split each of the one or more toolpaths which intersect with cut plane 1050 into two or more toolpaths. In some examples, cut plane 1050 is digitally added prior to ordering the one or more toolpaths such as step 850 of FIG. 8B. In other examples, cut plane 1050 is digitally added when generating the G-code such as step 835 of FIG. 8A. Cut plane 1050 may be a plane which extends radially outwards from central axis CA as shown in FIG. 10C. Cut plane 1050 may be a plane which extends across central axis CA. Cut plane 1050 may be a wavy plane which is shaped as a saddle, a wave, or any other shape of cut plane 1050 which divides toolpaths.

FIG. 10D illustrates the dependencies of the example FIG. 10C. Toolpath 1052 depends on toolpath 1002, toolpath 1002 depends on toolpath 1004, toolpath 1004 depends on toolpath 1006, toolpath 1004 depends on toolpath 1006, toolpath 1006 depends on toolpath 1008, toolpath 1006 depends on toolpath 1010, but toolpath 1010 does not depend on any other toolpaths because cut plane 1050 removed the dependent portion of toolpath 1010. The toolpaths of FIGS. 10C and 10D are acyclic as none of the toolpaths depend on any prior toolpath.

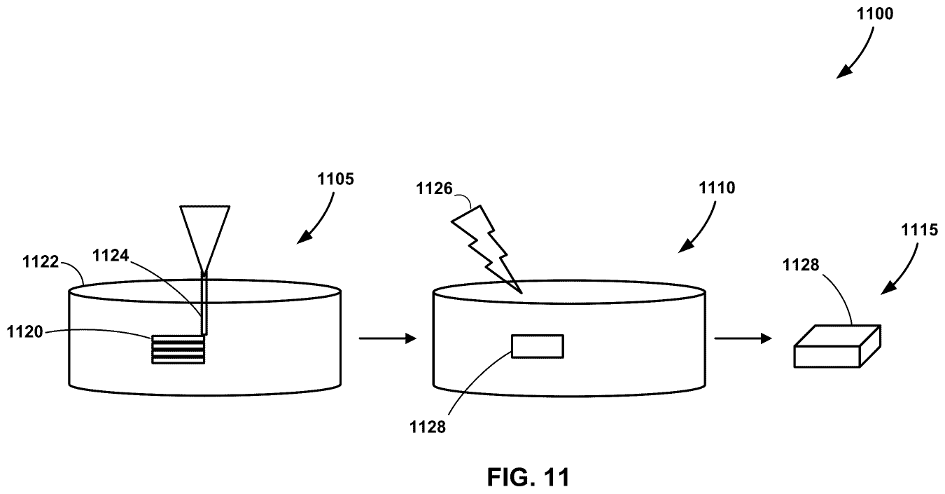

FIG. 11 is a pictorial representation of 3D printing process 1100. The process in FIG. 11 is an illustration of the FRESH 3D printing process. Material is deposited in 3D in the gelatin microparticle support medium, then the printed material is cured, and the FRESH support may be melted and removed.

In an example, a left ventricle silicone model may be 3D printed using a custom-built Acrotech 3D printing station, controlled by an A3200 multi-axis motion controller. Ultimus V pneumatic dispensing controllers may apply a constant pressure of 30 kPa. Print speed may be set to 12 mm/sec. A 27 GA, metal needle may be attached to a 30 CC plastic, UV blocking syringe barrel. To support the material as it is deposited, a method referred to as freeform reversible embedding of suspended hydrogels (FRESH) may be used as shown in FIG. 11. FRESH 3D printing employs a gelatin microparticle support medium, which is displaced as ink 1120 is deposited by needle 1124 in a 3D shape based on G-code (1105). Support 1122 may self-heal after dispensing needle 1124 has passed through and support 1122 may maintain the structural integrity of printed object 1128 until ink 1120 is cured. UV light 1126 may be applied to cure ink 1120 into printed object 1128 (1110). After the object has been printed and cured, FRESH support medium 1122 is melted at 37° C. and removed (1115). Using a support bath, such as in the FRESH method, enables any 3D geometry without restrictions due to gravity. Ink 1120 may include individual cells suspended in a hydrogel in some examples.

There are some alternative approaches to this technique. For example, the G-code produced by this algorithm is interpretable by nearly any 3D printer, whether commercially available or custom built. All stated printing parameters may be modified based on the specific setup and application. Any material deposition strategy is compatible with this technology, not merely hydrogel-based 3D bioprinting. This could include biologic and nonbiologic materials, as well as biotic and abiotic applications.

While this process may be implemented for 3-axis bioprinters, there exist 3D printers and robotic deposition machines with more than 3 degrees of freedom. The algorithm may be updated using more than 3 degrees of freedom using the same techniques described herein.

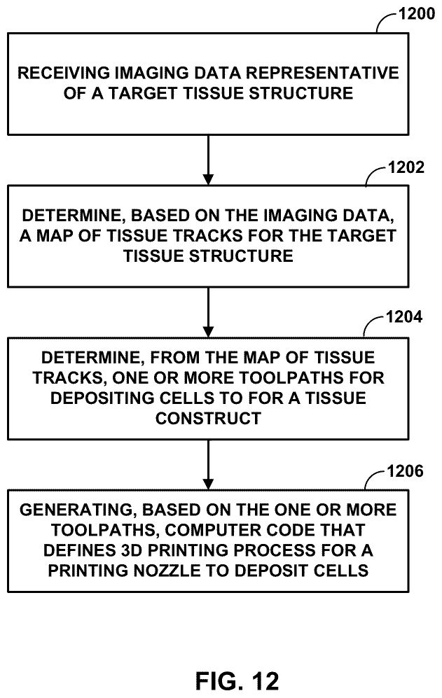

FIG. 12 is a flowchart of an example technique for determining a toolpath for printing a tissue construct. The processing circuitry may receive imaging data representative of a target tissue structure (1200), determine, based on the imaging data, a map of tissue tracks for the target tissue structure (1202), determine, from the map of tissue tracks (or streamlines), one or more toolpaths for depositing cells to form a tissue construct representative of the target tissue structure (1204), and generate, based on the one or more toolpaths, computer code that defines a three-dimensional (3D) printing process for a printing nozzle to deposit the cells to form the tissue construct (1206).

The process of FIG. 12 may be performed by processing circuitry of a single computing device or processing circuitry distributed over two or more devices. For example, one computing device may perform one or more processes while another computing device may perform other processes. In some examples, the system may request, or receive, user input correcting or adjusting any aspect of the process.

As shown in the example of FIG. 12, the processing circuitry may receive imaging data representative of a target tissue structure (1200). For example, the imaging data may be DTMRI data for a biological sample structure that is the target of the printed tissue construct. In other examples, different imaging modalities may generate the tissue tracks. Example imaging modalities include X-ray, Computed Tomography (CT), or MicroCT. The target tissue may be an organ, connective tissue, or any other biological structure to be printed. Receive imaging data representative of a target tissue structure (1200) may additionally or alternatively be implemented in a similar manner to receiving directional imaging data as described with reference to 840 of FIG. 8B above.

The processing circuitry may then determine, based on the imaging data, a map of tissue tracks for the target tissue structure (1202). This process may be referred to as tractography or some other method of determining the fibers or orientation of cells within the target tissue structure according to the imaging data. In other examples, the system may not need to perform this step of determining the tissue tracks, as the system may directly receive the map of tissue tracks already completed. Determining, based on the imaging data, a map of tissue tracks for the target tissue structure (1202) may additionally or alternatively be implemented in a similar manner to generating streamlines based on directional imaging data as described with reference to 845 of FIG. 8B above.

The processing circuitry may then determine, from the map of tissue tracks (or streamlines), one or more toolpaths for depositing cells to form a tissue construct representative of the target tissue structure (1204). In general, the processing circuitry may change at least one or more of the tissue tracks in order to generate the one or more toolpaths. In some examples, the processing circuitry determines the one or more toolpaths by modifying a density of the tissue tracks in the map to accommodate a cell printing width for the printing nozzle. The change in tissue tracks may be a reduction in the density of tissue tracks, which may be selective or random removal of one or more tissue tracks. For example, the reduction of tracks may include iteratively thinning the map of tissue tracks to a reduced density of tissue tracks corresponding to the one or more toolpaths, randomly selecting a subset of tissue tracks from the map of tissue tracks, where the subset of tissue tracks corresponding to the one or more toolpaths, or iterative random selection of a subset of tissue tracks from the map of tissue tracks, the subset of tissue tracks corresponding to the one or more toolpaths. The processing circuitry may also order the reduced or otherwise changed tissue tracks into the one or more toolpaths. In some examples, the system may not need to perform this step of changing the tissue tracks. Then, the system could proceed directly to determining the computer code from the tissue tracks as the toolpaths. Determining, from the map of tissue tracks (or streamlines), one or more toolpaths for depositing cells to form a tissue construct representative of the target tissue structure (1206) may additionally or alternatively be implemented in a similar manner to partitioning one or more streamlines 850, thinning one or more streamlines 855, determining dependencies between the one or more streamlines 860, removing cyclicality between the one or more streamlines based on the dependencies 865, ordering the one or more streamlines into toolpaths 870, and/or post processing the one or more toolpaths 875 as described in FIG. 8B above.

Once the toolpaths and/or order have been determined, the processing circuitry may generate, based on the one or more toolpaths, computer code that defines a three-dimensional (3D) printing process for a printing nozzle to deposit the cells to form the tissue construct (1206). In some examples, the computer code includes G-code commands. The processing circuitry may transmit the computer code to the 3D printing system. The processing circuitry may control, based on the computer code, one or more motors coupled to the printing nozzle to deposit the cells along the one or more toolpaths to generate the tissue construct. In some examples, the printing nozzle may be configured to print pre-aligned microtissues where the cell, or cells, of the microtissue has been pre-aligned in a single direction before printing. In some examples, after printing, the printed tissue construct is matured in a biorcactor. Generating, based on the one or more toolpaths, computer code that defines a three-dimensional (3D) printing process for a printing nozzle to deposit the cells to form the tissue construct (1202) may additionally or alternatively be implemented in a similar manner to generating g-code based on the post-processed toolpath and 3D printing the G-code as described with reference to 880 and 885, respectively, of FIG. 8B above.

Some examples, described herein are related to specific applications of DTMRI data in 3D bioprinting engineered tissues. Beyond the examples of FIGS. 1 and 4A-5C, i.e., GEJ and heart, DTMRI imaging has applications in many tissues and organs, including, but not limited to, brain tissue, connective tissue, epithelial tissue, nervous tissue, tendonous tissues, cartilage tissue, ligamentary tissues, renal tissue, respiratory tissue, connective tissue, eyes, the spinal cord, skeletal muscle, smooth muscle, scar tissue, ophthalmic tissue, auditory tissues, reproductive tissues, and bone. DTMRI imaging is also used in many medical and commercial applications. One emerging area of interest in the medical field is using DTMRI to diagnose cellular injuries, using cellular swelling as a metric. Examples include stroke, heart attack, and traumatic brain injury. Non-biological materials that have been imaged and analyzed using DTMRI include wood, porous rock, electrospun fibers, polymer composites, and glass capillaries.

There are applications of traditional MRI imaging that could be expanded into DTMRI to glean insights into materials. In agriculture and food production, applications of DTMRI include determination of muscle structure, connective tissue locations, fat content analysis, fiber content, and plant structure. This also applies to wood and paper products. For example, DTMRI may enhance the quality and safety of food production. Such improvements to quality and safety of food production could occur through improvements to the detection of foreign bodies, maturity evaluation of fruits, bruise detection of fruits, determination of fruit yield, fractal analysis, and many other quality parameters associated with food. DTMRI could be beneficial in evaluating irrigated land mapping, canopy measurement, vegetation indices, etc., with larger precisions by providing unique information on the functional architecture of certain biological tissue organization.

Industrial applications of DTMRI include liquid crystal display analysis, investigating the structure of solid rocket fuel, assessing muscle, fat, and connective tissue structure in tissue, assessing fibrous structure of plants and trees, and determining the impact of hydration on concrete and cement during the curing process. DTMRI and one or more aspects of this disclosure may be applied to any industrial application. Specifically, DTMRI may be beneficial in any industrial application involving micro-structures with any micro-architecture which promotes or opposes diffusion of water molecule diffusion in any direction. Industrial applications of DTMRI may be paired with one or more algorithms in examples described herein to create one or more toolpaths which represent one or more of the micro-structures of the target structure. Toolpaths may be edited, where the edited toolpaths may alter one or more mechanical or other properties of an object printed based on those toolpaths. Specifically, G-code may be created based on the altered toolpaths and printed by a 3D printer. In some examples, a target structure may be scanned by DTMRI where the target structure is an industrial application such as those described below, the toolpaths of the scanned target structure may be altered, thereafter G-code may be created based on the altered toolpaths, and the G-code may be printed by a 3D printer to yield a construct. Such an example of scanning with DTMRI, altering toolpaths, creating G-code, and then printing the G-code may enable rapid prototyping of structures with complex microarchitecture or fibrous structures which traditional MRI or 3D printing may be incapable of accurately detecting or reproducing.

Liquid Crystal Displays (LCDs) are a type of flat-panel display that may use the light-modulating properties of liquid crystals combined with polarizers to produce visible images. Liquid crystals do not emit light directly, but instead use a backlight or reflector which produces light and liquid crystals obscure the light in specific patterns to produce images in color or monochrome. Liquid crystals may be 3D printed by leveraging the properties of liquid crystals and UV-sensitive resin by flashing complete layers at the resin tank and a screen may mask the entire image, only revealing the current layer for curing. Such a technique may reduce pixel distortion, which is a common issue with other methods like DLP printing. The UV-sensitive resin used in this process may be a free-radical/cationic hybrid photosensitive resin. In other examples, the resin may be sensitive to any other wavelength of electromagnetic radiation. DT MRI is a technique may visualize and detect defects within structures using tensor shape characteristics of the LCD compared to a template which contains no such defects. Shape metrics may potentially be used for direct tensor visualization and for detection of defects within the liquid crystal matrix. DTMRI may additionally or alternatively be used for microstructure analysis to modify and improve the performance of the LCD screens.

Solid rocket fuel is a propellant which has its fuel and oxidizer mixed together into a solid composite. The combustion of this propellant is an exothermic chemical reaction and the regression rate of the propellant, which is the rate at which the propellant burns, is a key factor in the performance of a solid rocket. DTMRI may be configured to visualize and measure the diffusion of particles within the solid propellant to potentially provide insights into the combustion process and the behavior of the propellant under different conditions. DTMRI may additionally or alternatively assess the packing of materials in a solid rocket fuel booster prior to use whether or not the fuel booster has been 3D printed. Solid rocket fuel materials typically are composite materials, which may include a crystalline oxidizer (such as Ammonium Perchlorate (AP) or Ammonium Nitrate (AN)), a binder (such as Hydroxyl-Terminated Polybutadiene (HTPB), Polybutadiene Acrylonitrile (PBAN), or Polyurethane (PU)), and a metal fuel (usually Aluminum). Solid rocket fuel may additionally or alternatively include glycidyl azide polymer (GAP) and ammonium perchlorate (AP) composites, lead styphnate (LS) or composite with nitrocotton, hydroxyl-terminated polybutadiene (HTPB)/AP, gunpowder (75% potassium nitrate, 15% charcoal, and 10% sulfur). For example, Ariane 5, a now retired European space launch vehicle, uses solid fuel boosters, which combine aluminum powder as the fuel, ammonium perchlorate as the oxidant, and polybutadiene acts as a binder to hold the mixture together. In some examples, a solid rocket fuel booster could be 3D printed based on one or more aspects of this disclosure. In some examples, a TNT based explosive or barrel-based weapons propellants may additionally or alternatively be printed based on one or more aspects of this disclosure. Specifically, 3D extrusion may fabricate TNT based explosives, nitrocellulose based propellant, and composite solid propellant. Selective laser sintering (SLS) may fabricate high explosive from RDX-based microparticles. Drop-on-demand inkjet printers may produce macro- and nano-scale energetic composites composed of RDX and cellulose acetate butyrate (CAB) matrix. In the field of gun propellants, the DLP (digital light processing) printing technique of Vat photopolymerization may be configured to fabricate photocurable gun propellants in TNO. Such 3D printed structures may be scanned, analyzed, modified, and/or printed according to one or more aspects of this disclosure.

DTMRI may be configured to assess not only muscle structure but also fat and connective tissue locations in tissues, which could be applied to 3D printed or lab-grown meats (or other foods) to replicate the taste and texture of the lab-engineered food product more accurately. 3D printed tissues, such as meat or other commercial tissues, may be scanned, analyzed, modified, and/or printed according to one or more aspects of this disclosure.

A tissue may be printed using a 3D A high precision Ultimus™ V EFD pneumatic controller dispenser used in combination with an Acrotech nanopositioning stage for controlled spatial material deposition, where toolpaths may be converted to G-code using an extruding travel speed of 3 mm/s and a non-extruding travel speed of 10 mm/s. The pneumatic controller may be connected to a standard pipette syringe mounted on the Acrotech nanopositioning stage where the pipette syringe may be capped with a standard 22 gauge, 1″ long stainless steel tip. In some examples, for a silicone model the print material may be 75% (w/w) all-purpose waterproof silicone sealant, 20% (w/w) silicone oil, and 5% (w/w) PlatSil low viscosity deadener. In some examples, a bioink may be configured to produce living tissue, wherein the bioink may use any materials which form tissue when extruded with or without processing. Ink materials may be mixed immediately before printing and loaded into the syringe. To remove bubbles, the syringe may be centrifuged at 1,000 RCF for 1 minute. A plastic piston may be added to the syringe after material loading with an extrusion pressure of 450 kPa. The freeform reversible embedding of suspended hyrdogels (FRESH) method may create the gelatin microparticle support medium. Such method may include 32% deionized water and 68% ethanol were mixed together at 45° C. and cooled to 10° C. while stirring in multiple stages. The solution may be collected in 50 mL tubes and centrifuged at 12,000 RCF for 4 minutes. After resuspending in cold deionized water, the mixture may be centrifuged again at 500 RCF for 5 minutes. Gelatin microparticles may be resuspended in cold PBS and stored in the refrigerator before use. The FRESH may cleared by performing an additional wash step with a 60% iodixanol solution for improved optical imaging. After printing, the tissue may be cured in the support bath for at least 24 hours before the support was melted at 37° C. and removed by aspiration.

Wood is a fundamental material for society, including the construction of buildings, furniture, and architectural structures as it has been for millennia. Wood is typically shaped through subtractive manufacturing techniques which generates substantial wood waste leading to inefficiency and cost. Subtractive manufacturing techniques are limited in structure shapes which the final product may take shape, for example internal cavities are effectively impossible to form through subtractive manufacturing techniques. Such potential wood structures and constructs may be printed with a 3D printer using a water-based ink composed of lignin and cellulose, the primary constituents of natural wood. Specifically, 3D printing of wood through direct ink writing (DIW), may enable the creation of complex wood structures with reduced waste, enhanced sustainability, and improved mechanical characteristics. DTMRI may enable a non-invasive method to analyze the internal structure and orientation of the cellulose fibers in wood, whether the wood is 3D printer or naturally occurring. DTMRI may provide details of the fibrous structure of wood through analysis of the diffusion patterns of water in the wood. One or more aspects of this disclosure may receive the DTMRI data from the scan of the wood and may alter the printing process and/or the printing products by aligning the fibers for strength and structural integrity based on the wood product being 3D printed, such as being similar to or an improvement upon the natural growth patterns found in wood. Such cyclical revisions of internal structure of a wood construct may improve the mechanical properties of a 3D-printed wood construct.

Concrete is a heterogeneous material with a complex internal structure. The performance of concrete is highly dependent on its internal structure and the interaction of those materials under different loading conditions. Visualization and measurement of the diffusion of water molecules through concrete with DTMRI may provide insights into the microstructure. Through one or more aspects of this disclosure, additives or other aspects of a concrete sample may be recursively tested. Specifically, an additive may be added to a sample of concrete which may be 3D printed, the sample may then be scanned by a directional scanning modality, the toolpaths of the scan may be modified to alter one or more characteristics of the toolpaths, and the modified toolpaths may be 3D printed. Such a process may repeat recursively. DTMRI may detect water diffusion and thereby determine the structure of concrete by detecting water while the cement paste is still wet. DTMRI may be applied to understand water diffusion and evaporation, which impacts microstructure and mechanical properties of concrete and may additionally or alternatively inform the impact of hydration on concrete and cement during the curing process. DTMRI may also detect fractures or defects in concrete. Crack widths may be calculated from the MR image and from the properties of the MR signal. Concrete may be formed of cement, aggregates, water, chemical admixtures, and reinforcing materials. For cement, Portland cement is commonly used, which is made of calcareous material containing calcium compounds (often made from limestone, clay, fly ash, sandstone, or shale), alumina, silica, and iron oxide. Aggregates may be stone and/or sand and are generally designated as either fine (ranging in size from 0.025 to 6.5 mm) or coarse (from 6.5 to 38 mm or larger). Chemical admixtures and mineral admixtures may be added to enhance the properties of the concrete. Reinforcing materials may include reinforcing bars, welded wire fabric (wire mesh), and various reinforcing fibers. In some examples, a concrete structure could be 3D printed by depositing uncured concrete at desired locations based on one or more aspects of this disclosure.

Any material that is anisotropic, fibrous, and nonferrous may be imaged using DTMRI. The systems described herein can generate toolpaths using this information and then apply the toolpaths to 3D printing or otherwise the deposition process of desired materials. As rapid prototyping, 3D printing, robotic processes, and other automation technologies become more and more prevalent, a capability to translate alignment data acquired via imaging to machine code may improve 3D printing processes.

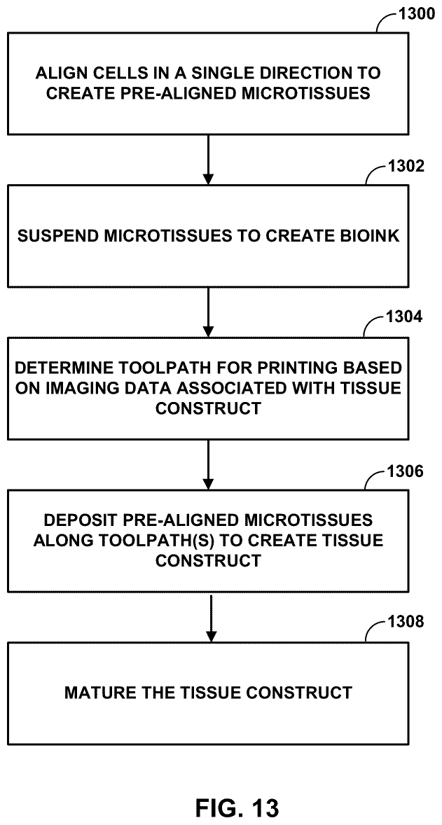

FIG. 13 is a flowchart of an example technique for printing a tissue construct using pre-aligned microtissues according to a toolpath based on directional imaging data. Printing a tissue construct using pre-aligned microtissues according to a toolpath based on directional imaging data may include aligning cells in a single direction to create pre-aligned microtissues (1300), suspending microtissues to create bioink (1302), determining toolpath for printing based on imaging data associated with tissue construct (1304), depositing pre-aligned microtissues along toolpath(s) to create tissue construct (1306), and maturing the tissue construct (1308).

In the example of FIG. 13, an operator or an automated machine aligns cells in a first direction to create pre-aligned microtissues (1300). In one example, muscle cells are matured using bioreactor signals so that the muscle cells are aligned in a single direction to form one or more aligned microtissues. Aligned muscle cells may be formed by suspending cell-laden hydrogels between attachment structures in small wells of a substrate. In one example, each of the wells have rubber posts at each end of each well.

As cells remodel the hydrogel, they may cause the gel to undergo compaction, inducing a strain in the hydrogel between the two anchoring posts. The muscle cells align with their long axis parallel to the strain, resulting in highly aligned microtissues. In other examples, different structures other than posts may be used. For example, attachment structures may include microgrooves, other tissue suspended between edges or ends of structures, and/or any other structure that may constrain cells in a single direction. When released from the attachment points (e.g., cut from the posts or cut from other tissue at ends of a channel), the resulting microtissues include pre-aligned cells and may be ready to be printed, or deposited, into suitable shapes. In other examples, the microtissues may be created by first spinning the cells into a long fiber having a length that corresponds to the single direction of the alignment, and then cutting the long fiber into microtissues with lengths corresponding to the single direction of the alignment. In some examples, microtissues are created to have widths or diameters from approximately 100 mm to approximately 300 mm, but smaller or larger widths may be used in other examples. In some examples, microtissues are created to have lengths from approximately 5 mm to approximately 10 mm, but smaller or larger lengths may be used in other examples. For example, spinning the cells into a fiber may generate microfibers of any suitable length. In other examples, microtissues are formed with pre-aligned cells using techniques other than strain between posts, such as using grooved (nanogroove) patterning of wells, electrical field alignment, or chemical alignment.

The pre-aligned microtissues may then be combined (e.g., suspended) with a liquid (e.g., liquid or gel) to create a bioink (1302). For example, for aligned tissue bioprinting, pre-aligned microtissues (e.g., microtissues with a diameter of 250 μm and a length of 1 cm) may be aligned in the printing direction when printed as a suspension in GelMA bioink. The system may also determine the toolpath(s) for printing based on the imaging data associated with the tissue construct, as described herein (1304).

A nozzle may then deposit the bioink laden with pre-aligned microtissues or individual cells into a larger tissue construct with different suitable orientations (e.g., a suitable direction of alignment at different parts of the construct using the single direction alignment of the microtissues) (1306). For example, rather than scaling-up the size of existing methods, pre-aligned and pre-vascularized microtissues may be produced and then used as “building blocks” in a 3D bioprinter to make larger tissue constructs. This approach may move much of the tissue maturation process to the beginning of the process (e.g., creating the microtissues used in the bioink) rather than the end (i.e., after all cells are printed at the tissue construct). This may decrease the complexity during final maturation in a bioreactor. Bioprinting of pre-matured microtissues may result in enhanced control over tissue alignment and vascularization. In some examples, the nozzle may enable printing a 3D structure with the pre-aligned microtissues being deposited across two-dimensions and in height to create the 3D tissue construct. In other examples, the nozzle may print multiple two-dimensional layers of microtissues, and then the different two-dimensional layers may be arranged and layered as suitable to create a 3D layered tissue construct. In other examples, the printing process may include winding of microtissues as a longer fiber along the toolpaths in order to create the tissue construct.

The tissue construct may then be matured in a bioreactor (1308). Although, the approach discussed above may move much of the tissue maturation process to the beginning of the process rather than the end, final maturation of the tissue construct may be needed to grow the tissue construct and enable functionality and stability between the deposited microtissues. Bioprinting of pre-matured and pre-aligned microtissues may result in enhanced control over tissue alignment and vascularization. This may decrease the complexity during final maturation of the tissue construct in a bioreactor.

FIG. 14 is a graphical representation 1400 of pre-aligned microtissues 1402 in accordance with an example of this disclosure. A problem when creating a GEJ, such as GEJ 100 of FIG. 1 or a left ventricle of a heart of a patient, such as the example shown in FIGS. 4A-5C, or other complex tissues using such a workflow is that making a bioreactor to achieve the complex anatomical structure and also induce vascularization is prohibitively complex. One or more examples described herein may create mature microtissues while the tissues are still on a manageably small scale. These pre-matured and pre-aligned microtissues 1402 may then be used as building blocks to create larger tissues without a bioreactor to achieve alignment and vascularization according to the determined toolpaths for the tissue construct. For the purpose of printing aligned gSMC bundles, an advanced bio-ink may be made from pre-aligned microtissues 1402, rather than individually suspended cells as is done in traditional bioprinting. A combination of geometric constraints and fluid flow alignment may print the microtissues 1402 end-to-end as they are released from printing nozzle 1404. In some examples, microtissues 1402 may then fuse to form a fascicle or bundle of structures. One or more examples described herein disclose a tissue engineering method for continuous extrusion bioprinting of smooth muscle bundles that are similar to those found in the native GEJ or other structures with varying alignment of fibers.

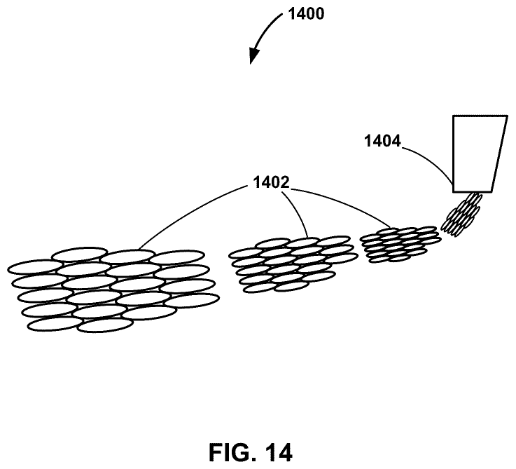

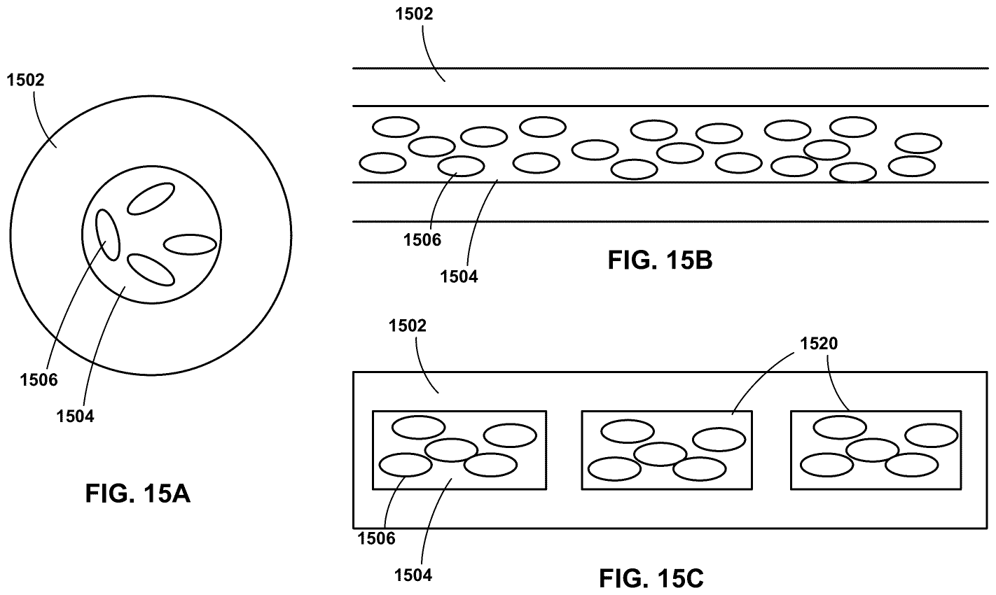

FIGS. 15A, 15B, and 15C are example cross-section and profile views of example fibers generated using a core-shell spinning technique. Within shell 1502 may be hydrogel 1504 and cells 1506. One example process for microtissue formation involves a casting process. Hydrogels 1504 and cells 1506 may be cast into a mold to form the pre-aligned microtissues. Cells 1506 may become pre-strained during curing of cells 1506 in hydrogels 1504. For example, a different method of production of pre-aligned microtissues may utilize a core-shell wet spinning approach. This process of co-axial or core-shell spinning may produce very long fibers made from cells 1506 and hydrogel 1504, within shell 1502. In this core-shell approach, cells 1506 may proliferate and exert contractile force in hydrogel 1504, which leads to alignment of cells 1506 along the complete fiber direction (e.g., in the direction parallel with a longitudinal axis of the fiber. The material of shell 1502 may be dissolved away after maturation, leaving only the core cellular fiber behind, which include cells 1506 as part of pre-aligned microtissues.

The technique may use the wet spinning method to create long fibers or microtissues which will then be divided into smaller tissues and collected for use in bioprinting. For example, wet spinning may produce a continuous fiber which may then be cut into smaller pieces. These smaller pieces may be formed into a “pulsed fiber” as shown in FIG. 15C which may compartmentalize small pieces of cellular core material (e.g., cells 1506 and hydrogel 1504) into discrete microtissue units 1520. Rather than cutting a long fiber into smaller fibers, the technique may simply dissolve away the material of shell 1502 in order to expose individual microtissue units 1520 for collection and printing along the determined toolpaths for the tissue construct.

In one example, the technique may use alginate as a shell material, which encases a core of cells and collagen or some other suitable pre-gel solution. After maturation of the cells and collagen into a microtissue, the technique may involve dissolving the alginate shell material by chelation of calcium ions or by an alginate degrading enzyme such as alginase. Microtissues may be produced as short lengths (lengths between approximately 200-500 microns and length to width aspect ratios between approximately 2:1-5:1), enabling high printing resolution and small curvature radius during the following bioprinting process. Microtissues may also be produced as longer segments (lengths between approximately 500-2000 microns) and a high aspect ratio (e.g., length to width aspect ratios of 5:1-20:1), which may enable better physical entanglement and strength of any tissues printed with these microtissues. This process may enable a system to generate discrete and repeatable microtissue units 1520 in a very rapid manner.

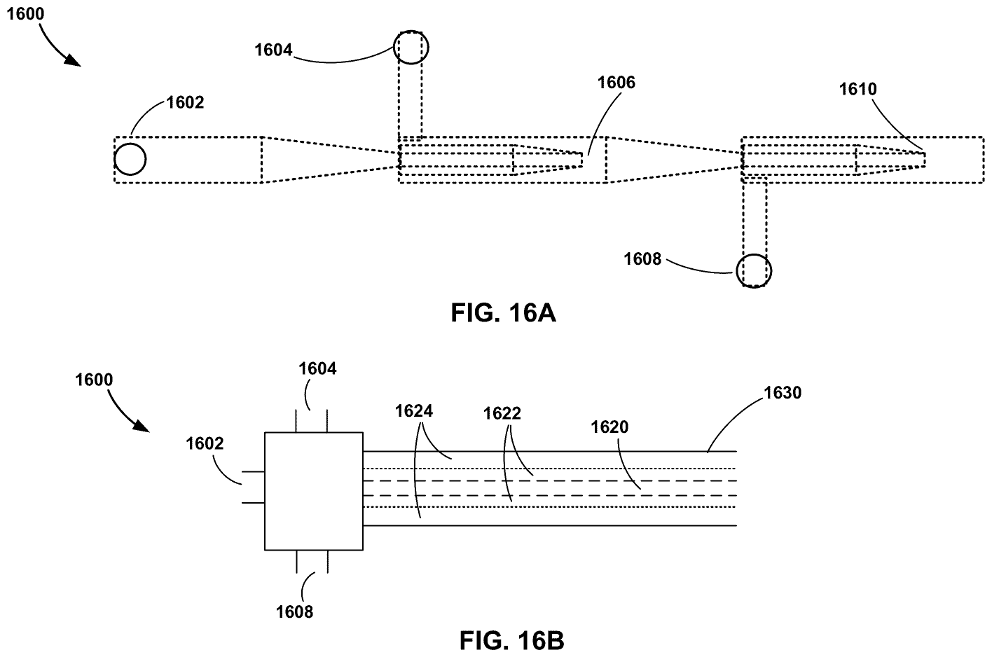

FIGS. 16A and 16B are conceptual diagrams of an example spinning device 1600 for wet spinning microtissues such as the fibers and microtissue units 1520 of FIGS. 15A, 15B, and 15C. Spinning device 1600 may control the size of the core fiber by controlling the flow rates of the material (e.g., shell material, cells, and hydrogel, through spinning device 1600.) The microtissue units generated by spinning device 1600 may be loaded into a printer and deposited by the bioprinter according to the determined toolpaths defined by the G-code, for example, in a non-continuous manner, such as for complicated structures like a heart (e.g., FIGS. 4A-5C), gastroesophageal junction (e.g., GEJ 100 of FIG. 1), etc. For example, these small microtissues may later be assembled into larger tissues by bioprinting to exert much more control over the quality and character of the final product.

As shown in the example of FIG. 16A, spinning device 1600 includes three different inlets, core stream inlet 1602, shell stream inlet 1604, and sheath stream inlet 1608. Each of these inlets injects material to form a respective portion of microtissue. Cells, such as cells 1506 of FIG. 15, and the core material, such as hydrogels 1504 of FIG. 15, are injected first through the core stream inlet 1602. Then, the shell material is added through shell stream inlet 1604 and added circumferentially around the core (e.g., at locations radially outward from the core) via spinneret 1606. This combined material may be referred to as the microtissue fiber or unit. Then, sheath material, such as shell 1502 of FIG. 15, is added through sheath stream inlet 1608 and added to the outside of the microtissue from spinneret 1606 via spinneret 1610 to create the output material that includes the microtissue that may be printed.

In this manner, spinning device 1600 may use a series of coaxial nozzles or spinnerets (e.g., spinnerets 1606 and 1610) to layer the shell material over the core that includes the cells to be pre-aligned within the shell. For example, spinneret 1606 may inject a stream of core fluid into the center of a larger stream of shell fluid. Then, the coaxial fluid streams are injected through second spinneret 1610 into the center of a larger stream of fluid (e.g., the sheath material) which may contain crosslinking chemicals to convert the coaxial core and shell streams into a solid fiber. All three streams may be introduced at the same point by a coaxial nozzle made of three independent nozzles of decreasing size inserted into each other.

The example of FIG. 16B illustrates a conceptual diagram of spinning device 1600. As shown, core stream inlet 1602, shell stream inlet 1604, and sheath stream inlet 1608 may converge within a fluid manifold that may take the form as shown in FIG. 16A or other fluid flow channels. Outlet material 1630 is shown as a cross-sectional view of the coaxial material and includes core stream 1620 in the middle, shell stream 1622 radially outward from core stream 1620, and sheath stream 1624 radially outward from shell stream 1622. In this manner, shell stream 1622 may depict the shell of the spun microtissue, which may provide structural support during development or pre-aligning of the cells. Core stream 1620 includes the core of the microtissue, which may contain cells and a hydrogel material, such as cells 1506 and hydrogel 1504 of FIG. 15, that develop into the aligned microtissue.

The flow rate of material out of spinning device 1600 may be varied based on cell size, hydrogel viscosity, or other factors. In one example, the flow rate may be between approximately 20 microliters per minute and 200 micro liters per minute. The flow rate may be between approximately 50 microliters per minute and 100 micro liters per minute. In an example at 50 microliters per minute, shell stream 1624 may have a diameter of approximately 285 micrometers, and core stream 1622 may have a diameter of approximately 94 micrometers. At 100 microliters per minute, shell stream 1624 may have a diameter of approximately 316 micrometers, and core stream 1622 may have a diameter of approximately 173 micrometers. These example dimensions are merely for illustrative purposes, as other flow rates and dimensions are possible by using different characteristics of the material and spinner device 1600.

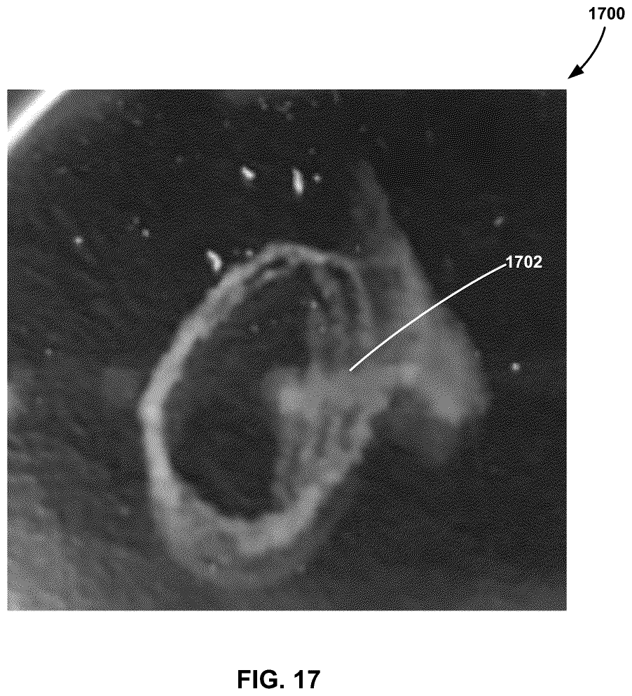

FIG. 17 is an image of example printed structure 1700 of a GEJ, such as GEJ 100 of FIG. 1, using G-code generated by any example described herein, including for example FIG. 8A and/or FIG. 8B. As shown in the example of FIG. 17, the 3D bioprinter may create complex shapes within a support bath using the generated G-code. To demonstrate the feasibility of printing with the G-code generated by any example described herein, a subsegment of the full .gcode output file generated for the GEJ was printed. The selected code snippet contained some of the upper circular paths representing the lower esophageal circular sphincter muscles, such as those represented by 108 of FIG. 1. These were printed using a Cellink BioX® printer with 10% GelMA dyed blue for better visualization. The process was performed in a support bath composed of gelatin microparticles. Once the printing process was completed, the structure was stabilized by crosslinking with UV light, then the gelatin support bath was melted away by heating to 37° C. FIG. 17 shows the resulting structure, with preserved circular paths, although some over-extrusion was seen along scam 1702.

The microtissues described herein may be used with smooth muscle cells and other cells and tissues. In some examples, the pre-aligned microtissues may create or build upon cardiac or skeletal muscle. In some examples, multiple types of microtissues may be printed simultaneously, such as to overlap or interdigitate fibers of skeletal muscle and tendon tissue which results in a strong bond between the two tissue types at various tissue type junctions. Creating strong musculotendinous junctions, for example, may be advantageous for treatment of sports injuries, battlefield injuries, and other high energy trauma to soft tissue or other tissues. In any case, the printer may be controlled according to the toolpaths determined from the imaging data of a target tissue structure.

The microtissues described herein may be printed in different environments, such as building a larger construct in-vivo or in-vitro. In-vitro construct building may be done prior to implantation of that construct in a subject or otherwise used for a suitable purpose. For in-vivo printing, the technique may involve directly printing pre-aligned microtissues to another native tissue. For example, the microtissues may be printed onto a native organ to fill a gap in muscle caused by disease or trauma, which may repair a tear in muscle. This process could also be used for tendons, cardiac muscle, or any other tissue. The system may align the fibers of the printed microtissues with the fibers of the native tissue. In this manner, printing of the pre-aligned microtissues described herein may be performed to treat injury, repair damage, replace tissue, extend native tissue, or otherwise fix a defect in native subject tissue.

Examples of the disclosure may demonstrate pre-maturing microtissue building blocks for addressing muscle tissue alignment and vascularization. The examples may provide for rearranging the traditional process flow. In other examples, new methods for creating aligned and vascularized muscle may be combined and used for tissue engineering. One or more examples described herein discuss using pre-aligned microtissues that are suspended in a bio-ink and printed using a 3D extrusion bioprinter.

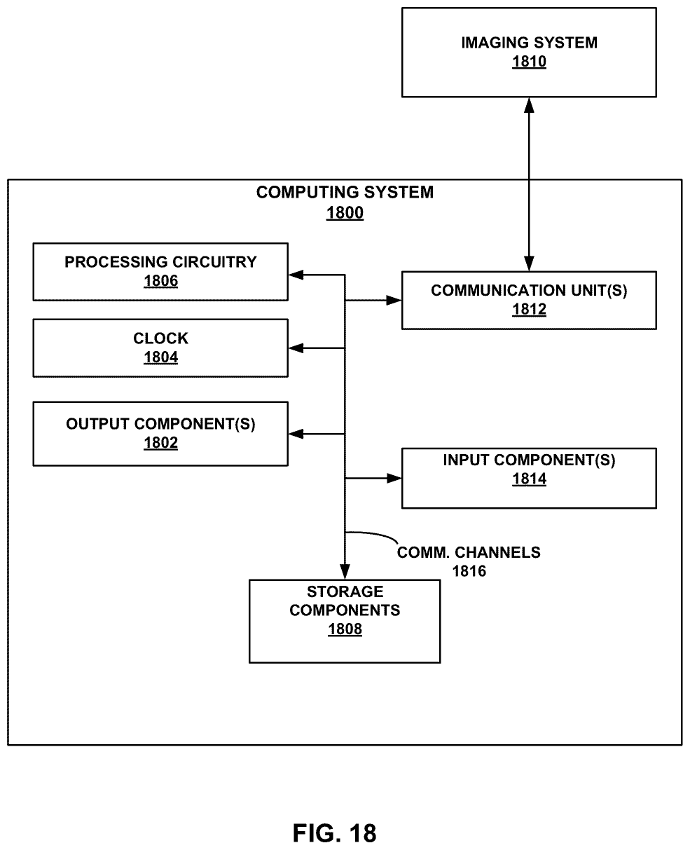

FIG. 18 illustrates one example of a computing system used to execute the techniques described herein, such as discussed with respect to FIGS. 1-17. Other examples of computing system 1800 may be used in other instances. Computing system 1800 may include a subset of the components included in example computing system 1800 or may include additional components not shown in example computing system 1800 of FIG. 18.

As shown in the example of FIG. 18, computing system 1800 includes processing circuitry 1806, one or more input components 1814, one or more communication units 1812, one or more output components 1802, and one or more storage components 1808. Processing circuitry 1806 may be an example of any processing circuitry herein. Communication channels 1816 may interconnect each of the components 1802, 1804, 1806, 1808, 1812, and 1814 for inter-component communications (physically, communicatively, and/or operatively). In some examples, communication channels 1816 may include a system bus, a network connection, an inter-process communication data structure, or any other method for communicating data.

One or more communication units 1812 of computing system 1800 may communicate with external devices, such as an imaging system 1810, via one or more wired and/or wireless networks by transmitting and/or receiving network signals on the one or more networks. In some examples, imaging system 1810 acquires, transmits, or provides pre-procedural images for processing as described above. Examples of communication units 1812 include a network interface card (e.g., such as an Ethernet card), an optical transceiver, a radio frequency transceiver, a GPS receiver, or any other type of device that can send and/or receive information. Other examples of communication units 1812 may include short wave radios, cellular data radios, wireless network radios, as well as universal serial bus (USB) controllers. Examples of imaging systems 1810 include computed tomography (CT) systems, Magnetic Resonance Imagery (MRI) systems, Diffusion Tomography Magnetic Resonance Imagery (DTMRI) systems, ultrasound systems such as transthoracic and transesophageal echo, and fluoroscopy systems.

One or more input components 1814 of computing system 1800 may receive input. Examples of input are tactile, audio, and video input. Input components 1814 of computing system 1800, in one example, includes a presence-sensitive input device (e.g., a touch sensitive screen), mouse, keyboard, voice responsive system, video camera, microphone or any other type of device for detecting input from a human or machine. In some examples, input components 1814 may include one or more sensor components one or more location sensors (GPS components, Wi-Fi components, cellular components), one or more temperature sensors, one or more movement sensors (e.g., accelerometers, gyroscopes), one or more pressure sensors (e.g., barometer), one or more ambient light sensors, and one or more other sensors (e.g., microphone, camera, infrared proximity sensor, hygrometer, and the like).

One or more output components 1802 of computing system 1800 may generate output. Examples of output are tactile, audio, and video output. In other examples, output may be a 3D printed object or a 3D bioprinted object. Output components 1802 of computing system 1800, in one example, includes a sound card, video graphics adapter card, speaker, liquid crystal display (LCD), or any other type of device for generating output to a human or machine. In other examples, output components 1802 of computing system 1800 include a 3D printer, a 3D bioprinter, or any other device capable of producing physical objects from a digital or analog representation thereof. In other examples, processing circuitry 1806 may control communication unit(s) 1812 to deliver toolpaths or other information that a 3D printer or other device or system can deposit material according to the instructions that may include the determined toolpaths.

Processing circuitry 1806 may implement functionality and/or execute instructions associated with computing system 1800. Examples of processing circuitry 1806 include application processors, display controllers, auxiliary processors, one or more sensor hubs, and any other hardware configure to function as a processor, a processing unit, or a processing device. Processing circuitry 1806 of computing system 1800 may retrieve and execute instructions stored by storage components 1808 that cause processing circuitry 1806 to perform operations for processing image data as described above. The instructions, when executed by processing circuitry 1806, may cause computing system 1800 to store information within storage components 1808.

One or more storage components 1808 within computing system 1800 may store information for processing during operation of computing system 1800. In some examples, storage component 1808 includes a temporary memory, meaning that a primary purpose of one example storage component 1808 is not long-term storage. Storage components 1808 on computing system 1800 may be configured for short-term storage of information as volatile memory and therefore not retain stored contents if powered off. Examples of volatile memories include random-access memories (RAM), dynamic random-access memories (DRAM), static random-access memories (SRAM), and other forms of volatile memories known in the art.

Storage components 1808, in some examples, also include one or more computer-readable storage media. Storage components 1808 in some examples include one or more non-transitory computer-readable storage mediums. Storage components 1808 may be configured to store larger amounts of information than typically stored by volatile memory. Storage components 1808 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 1808 may include a memory configured to store data or other information associated with heart or blood vessel imaging or modelling, graft length or graft or pump implant location.

Clock 1804 is a device that allows computing system 1800 to measure the passage of time (e.g., track system time). Clock 1804 typically operates at a set frequency and measures a number of ticks that have transpired since some arbitrary starting date. Clock 1804 may be implemented in hardware or software.

Pre-operative imaging may enable modification of an image of target structure acquired by imaging system 1810 at one or more input components 1814 to yield a construct which may be transferred to a physical medium via one or more output components 1802. Such modifications at one or more input components modify one or more aspects of the target structure to improve a functioning, mimic a functioning, or otherwise use data from imaging system in the formation of the construct.

The techniques discussed above may be applied in 3D printing to determine a map of material tracks for a target structure, determine and form, from the map of material tracks, one or more toolpaths for depositing material to form a construct representative of the target structure, and generate computer code defines a three-dimensional (3D) printing process for a printing nozzle to deposit the material to form the construct.

Example 1: A method includes receiving, by processing circuitry, imaging data representative of a target structure; determining, by the processing circuitry and based on the imaging data, a map of material tracks for the target structure; determining, by the processing circuitry and from the map of material tracks, one or more toolpaths for depositing material to form a construct representative of the target structure; and generating, by the processing circuitry and based on the one or more toolpaths, computer code that defines a three-dimensional (3D) printing process for a printing nozzle to deposit the material to form the construct.

Example 2: The method of example 1, wherein determining the one or more toolpaths comprises modifying a density of the material tracks in the map to accommodate a material printing width for the printing nozzle.

Example 3: The method of any of examples 1 and 2, wherein determining the one or more toolpaths comprises iteratively thinning the map of material tracks to a reduced density of material tracks corresponding to the one or more toolpaths.

Example 4: The method of any of examples 1 through 3, wherein determining the one or more toolpaths comprises randomly selecting a subset of material tracks from the map of material tracks, the subset of material tracks corresponding to the one or more toolpaths.

Example 5: The method of any of examples 1 through 4, wherein determining the one or more toolpaths comprises iterative random selection of a subset of material tracks from the map of material tracks, the subset of material tracks corresponding to the one or more toolpaths.

Example 6: The method of any of examples 1 through 5, wherein determining the one or more toolpaths comprises selecting a subset of material tracks from the map of material tracks by excluding one or more other material tracks via sweep exclusion, the subset of material tracks corresponding to the one or more toolpaths.

Example 7: The method of any of examples 1 through 6, wherein determining the one or more toolpaths comprises: determining, from the map of material tracks, a reduced density of material tracks; and ordering the reduced density of material tracks into the one or more toolpaths.

Example 8: The method of any of examples 1 through 7, wherein the imaging data comprises diffusion tensor magnetic resonance imaging (DTMRI), and wherein each material track in the map of material tracks corresponds to a diffusion tensor associated with water molecule movement within the target structure.

Example 9: The method of any of examples 1 through 8, wherein generating the computer code comprises generating G-code commands.

Example 10: The method of any of examples 1 through 9, further comprising controlling, based on the computer code, one or more motors coupled to the printing nozzle to deposit the material along the one or more toolpaths to generate the construct.

Example 11: The method of example 10, wherein the material comprise pre-aligned microtissues.

Example 12: The method of any of examples 1 through 11, wherein the target structure comprises an organ.

Example 13: The method of any of examples 1 through 12, wherein the target structure comprises one of a gastroesophageal junction (GEJ) or a heart.

Example 14: A system includes receive imaging data representative of a target structure; determine a map of material tracks for the target structure based on the imaging data; determine one or more toolpaths for depositing material to form a construct representative of the target structure based on the material tracks; and generate computer code that defines a three-dimensional (3D) printing process for a printing nozzle to deposit the material to form the construct based on the toolpaths.

Example 15: The system of example 14, further comprising a 3D printer configured to deposit the material to form the construct based on the computer code.

Example 16: The system of example 15, further comprising a UV light configured to cure the deposited material and wherein the 3D printer is a 3D bioprinter.

Example 17: The system of any of examples 14-16, wherein the material is a silicone material.

Example 18: The system of any of examples 14-17, wherein the imaging data is directional imaging data comprising a diffusion tensor for each voxel of the imaging data of the target structure.

Example 19: The system of any of examples 14-18, wherein the determining the map of material tracks comprises path integrating the diffusion tensor of two or more voxels of the imaging data of the target structure.

Example 20: The system of any of examples 14-19, wherein the target structure is a liquid crystal display and wherein the material comprises liquid crystals or UV-sensitive resin.

Example 21: The system of any of examples 14-20, wherein the target structure is a solid rocket fuel booster and wherein the material is a solid rocket fuel material.

Example 22: The system of any of examples 14-21, wherein the target structure is a fibrous structure and the material comprises lignin or cellulose.

Example 23: The system of any of examples 14-22, wherein the material is a concrete material.

Example 24: A computer-readable medium includes receive imaging data representative of a target structure; determine a map of material tracks for the target structure based on the imaging data; determine one or more toolpaths for depositing material to form a construct representative of the target structure based on the material tracks; and generate computer code that defines a three-dimensional (3D) printing process for a printing nozzle to deposit the material to form the construct based on the toolpaths.

Example 25: The method of any of examples 1 through 12, wherein the material tracks are tissue tracts and wherein the target structure comprises muscle cells aligned according to the map of material tracks.

Example 26: The method of any of examples 1 through 12 and 21, further comprising maturing the construct in a bioreactor.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media, which includes any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable storage medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various aspects of the disclosure have been described. These and other aspects are within the scope of the following claims.

What is claimed is:

1. A method comprising:
receiving, by processing circuitry, imaging data representative of a target structure;
determining, by the processing circuitry and based on the imaging data, a map of material tracks for the target structure;
determining, by the processing circuitry and from the map of material tracks, one or more toolpaths for depositing material to form a construct representative of the target structure; and
generating, by the processing circuitry and based on the one or more toolpaths, computer code that defines a three-dimensional (3D) printing process for a printing nozzle to deposit the material to form the construct.

2. The method of claim 1, wherein determining the one or more toolpaths comprises modifying a density of the material tracks in the map to accommodate a material printing width for the printing nozzle.

3. The method of claim 1, wherein determining the one or more toolpaths comprises iteratively thinning the map of material tracks to a reduced density of material tracks corresponding to the one or more toolpaths.

4. The method of claim 1, wherein determining the one or more toolpaths comprises randomly selecting a subset of material tracks from the map of material tracks, the subset of material tracks corresponding to the one or more toolpaths.

5. The method of claim 1, wherein determining the one or more toolpaths comprises iterative random selecting of a subset of material tracks from the map of material tracks, the subset of material tracks corresponding to the one or more toolpaths.

6. The method of claim 1, wherein determining the one or more toolpaths comprises selecting a subset of material tracks from the map of material tracks by excluding one or more other material tracks via sweep exclusion, the subset of material tracks corresponding to the one or more toolpaths.

7. The method of claim 1, wherein determining the one or more toolpaths comprises:
determining, from the map of material tracks, a reduced density of material tracks; and
ordering the reduced density of material tracks into the one or more toolpaths.

8. The method of claim 1, wherein the imaging data comprises diffusion tensor magnetic resonance imaging (DTMRI), and wherein each material track in the map of material tracks corresponds to a diffusion tensor associated with water molecule movement within the target structure.

9. The method of claim 1, wherein generating the computer code comprises generating G-code commands.

10. The method of claim 1, further comprising controlling, based on the computer code, one or more motors coupled to the printing nozzle to deposit the material along the one or more toolpaths to generate the construct.

11. The method of claim 10, wherein the material comprise pre-aligned microtissues.

12. The method of claim 1, wherein the target structure comprises an organ.

13. The method of claim 1, wherein the target structure comprises one of a gastroesophageal junction (GEJ) or a heart.

14. A system comprising processing circuitry configured to:
receive imaging data representative of a target structure;
determine a map of material tracks for the target structure based on the imaging data;
determine one or more toolpaths for depositing material to form a construct representative of the target structure based on the material tracks; and
generate computer code that defines a three-dimensional (3D) printing process for a printing nozzle to deposit the material to form the construct based on the toolpaths.

15. The system of claim 14, further comprising a 3D printer configured to deposit the material to form the construct based on the computer code.

16. The system of claim 15, further comprising a UV light configured to cure the deposited material and wherein the 3D printer is a 3D bioprinter.

17. The system of claim 14, wherein the material is a silicone material.

18. The system of claim 14, wherein the imaging data is directional imaging data comprising a diffusion tensor for each voxel of the imaging data of the target structure.

19. The system of claim 14, wherein the determining the map of material tracks comprises path integrating the diffusion tensor of two or more voxels of the imaging data of the target structure.

20. The system of claim 14, wherein the target structure is a liquid crystal display, and wherein the material comprises one of liquid crystals or UV-sensitive resin.

21. The system of claim 14, wherein the target structure is a solid rocket fuel booster, and wherein the material is a solid rocket fuel material.

22. The system of claim 14, wherein the target structure is a fibrous structure, and wherein the material comprises one of lignin or cellulose.

23. The system of claim 14, wherein the material is a concrete material.

24. A computer-readable medium comprising instructions that, when executed, cause processing circuitry to:
receive imaging data representative of a target structure;
determine a map of material tracks for the target structure based on the imaging data;
determine one or more toolpaths for depositing material to form a construct representative of the target structure based on the material tracks; and
generate computer code that defines a three-dimensional (3D) printing process for a printing nozzle to deposit the material to form the construct based on the toolpaths.
